(19) United States
(12) Patent Application Publication
(10) Pub. No.: US 2016/0349497 A1
(43) Pub. Date: Dec. 1, 2016

(54) SYSTEM AND METHOD TO ACHIEVE A DESIRED WHITE POINT IN DISPLAY DEVICES BY COMBINING COMPLEMENTARY TINTED NATIVE WHITE COLORS

(71) Applicant: QUALCOMM MEMS Technologies, Inc., San Diego, CA (US)

(72) Inventors: Jian Jim Ma, Carlsbad, CA (US); Shen-Ge Wang, Milpitas, CA (US); Tallis Young Chang, San Diego, CA (US); John Hyunchul Hong, San Clemente, CA (US); Chih-Chun Lee, Taipei (TW); Sheng-Yi Hsiao, HsinChu (TW); Bor-shiun Lee, New Taipei City (TW); Hung-Yi Lin, Xinbei City (TW)

(21) Appl. No.: 14/722,502

(22) Filed: May 27, 2015

(51) Int. Cl. G02B 26/00

(52) U.S. Cl. CPC G02B 26/001

(57) ABSTRACT

This disclosure provides a display device that can achieve a neutral white color by combining a first tinted native white color produced by a first display element of the display device or a portion thereof with a second tinted native white color produced by a second display element of the display device or a portion of the first display element. The tint of the first tinted native white color and the second tinted native white color can be complementary to each other. The first tinted native white color and the second tinted native white color can be combined using spatial and/or temporal dithering.

### TECHNICAL FIELD

This disclosure relates to the field of display devices and more particularly to electromechanical systems based display devices.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

In IMOD-based display devices, the color displayed by the IMOD display element depends on the distance between the two plates or the height of the air gap. By varying the distance between the two plates or the height of the air gap, the IMOD display element can be configured to display a white color, a black color and a plurality of non-white and non-black primary colors.

### SUMMARY

The systems, methods and devices of this disclosure each have several innovative aspects, no single one of which is solely responsible for the desirable attributes disclosed herein.

One innovative aspect of the subject matter described in this disclosure can be implemented in a display device comprising a first display element and a second display element. Each of the first and second display elements can include a movable reflector disposed over a substrate. The movable reflector can be spaced apart from the substrate by a gap. The first display element can be configured to produce a first tinted native white color and the second display element can be configured to produce a second tinted native white color, the tint of the first tinted native white color can be complementary to the tint of the second tinted native white color. A height of the gap of the first display element can be configured to display the first tinted native white color and a height of the gap of the second display element can be configured to display the second tinted native white color such that a neutral white color is produced by combining the first and the second tinted native white colors using spatial dithering.

In various implementations, the first native white color can be a yellowish-tinted white state having a color temperature between about 3000 K and about 4500 K measured along the specular direction with a D65 source without front screen optics. The movable reflector of the first display element can include a coating layer having a thickness between about 38 nm and about 54 nm. In various implementations, the coating layer can include titanium oxide. The second tinted native white color can be a cyanish-tinted native white color having a color temperature between about 8500 K and about 20,000 K measured along the specular direction with a D65 source without front screen optics. The movable reflector of the second display element can include a coating layer having a thickness between about 12 nm and about 28 nm. In various implementations, the coating layer can include titanium oxide. The display device can include a first display pixel including the first display element and a second display pixel including the second display element. The first and the second display pixels can be disposed adjacent to each other in a checkboard pattern or a random pattern.

Another innovative aspect of the subject matter described in this disclosure can be implemented in a display device comprising a display element including a first optical cavity and a second optical cavity. The first optical cavity can include a first portion of a movable reflector disposed over a substrate and the second optical cavity can include a second portion of the movable reflector disposed over the substrate. The first optical cavity can be configured to produce a first tinted native white color and a plurality of display primary colors. The second optical cavity can be configured to produce a second tinted native white color and a plurality of display primary colors. The first and the second tinted native white colors can be complementary to each other. A height of a gap between the first optical cavity and the substrate can be configured to produce the first tinted native white color, and a height of a gap between the second optical cavity and the substrate can be configured to produce the second tinted native white color. The display element can be configured to display a neutral white color produced by combining the first and the second tinted native white colors using spatial color mixing.

In various implementations, the first tinted native white color can be a yellowish-tinted white color having a color temperature between about 3000 K and about 4500 K measured along the specular direction with a D65 source without front screen optics. The first portion of the movable reflector can include a coating layer having a thickness between about 38 nm and about 54 nm. In various implementations, the coating layer can include titanium oxide. In some implementations, the second tinted native white color can be a cyanish-tinted native white color having a color temperature between about 8500 K and about 20000 K measured along the specular direction with a D65 source without front screen optics. The second portion of the movable reflector can include a coating layer having a thickness between about 12 nm and about 28 nm. In various implementations, the coating layer can include titanium oxide.

Another innovative aspect of the subject matter described in this disclosure can be implemented in a display device comprising a first means for displaying and a second means for displaying. Each of the first and second displaying means can include a movable means for reflecting disposed over a substrate, the movable reflecting means can be spaced apart from the substrate by a gap. The first displaying means can be configured to produce a first tinted native white color and the second displaying means can be configured to produce a second tinted native white color. The tint of the first tinted native white color can be complementary to the tint of the second tinted native white color. A height of the gap of the first displaying means can be configured to display the first tinted native white color and a height of the gap of the second displaying means can be configured to display the second tinted native white color such that a neutral white color is produced by combining the first and the second tinted native white colors using spatial dithering.

In various implementations, the first displaying means can include a first display element and the second displaying means can include a second display element. In some implementations, the first displaying means can include a first optical cavity and the second displaying means can include a second optical cavity. The reflecting means can include a reflector or a portion thereof.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIG. 3 is a graph illustrating movable reflective layer position versus applied voltage for an IMOD display element.

FIG. 4 is a table illustrating various states of an IMOD display element when various common and segment voltages are applied.

FIG. 5 is a flow diagram illustrating a manufacturing process for an IMOD display or display element.

FIGS. 6A-6E are cross-sectional illustrations of various stages in a process of making an IMOD display or display element.

FIGS. 7A and 7B are schematic exploded partial perspective views of a portion of an electromechanical systems (EMS) package including an array of EMS elements and a backplate.

FIG. 8 shows a cross-section of an implementation of an analog IMOD (AIMOD).

FIG. 9A illustrates an implementation of an EMS display element that is configured to produce a bright tinted native white state and a complementary primary color that is also bright and has a low contrast ratio with respect to the tinted native white state that results in a neutral white color when combined with the tinted native white state.

FIG. 9B-1 shows the simulated reflectance spectrum of the yellowish-tinted native white state and a cyan primary color for an implementation of a display element.

FIG. 9B-2 is a chromaticity diagram showing the simulated dithered white point achieved by spatially and/or temporally dithering the yellowish-tinted native white state with the cyan primary color in the (u′, v′) color space.

FIG. 9C-1 shows the simulated reflectance spectrum of the cyansih-tinted native white state and a yellow primary color for an implementation of a display element.

FIG. 9C-2 chromaticity diagram showing the simulated dithered white point achieved by spatially and/or temporally dithering the cyanish-tinted native white state with the yellow primary color in the (u′, v′) color space.

FIG. 10A-1 illustrates an implementation of a first display element that is adapted to produce a cyanish-tinted white state. FIG. 10A-2 illustrates an implementation of a second display element that is adapted to produce a yellowish-tinted white state.

FIG. 10B illustrates the reflectance spectrum of the first display element in the down state, the second display element in the down state and the combined reflectance spectrum produced using spatial and/or temporal dithering.

FIG. 10C illustrates the chromaticity diagram showing the neutral white color obtained by combining a cyanish-tinted white state with a yellowish-tinted native white state using spatial and/or temporal dithering.

FIG. 10D illustrates a portion of a display device including an array of display elements.

FIG. 11A illustrates an implementation of a display element including an optical stack disposed over a substrate. The display element includes a first portion including a first movable reflector disposed over the optical stack and spaced apart from the optical stack by a gap. The display element further includes a second portion including a second movable reflector also disposed over the optical stack and spaced apart from the optical stack by the gap.

FIG. 11B illustrates the reflectance spectrum of the first portion of the display element in the down state, the second portion in the down state and the combined reflectance spectrum produced using spatial and/or temporal dithering.

FIG. 11C illustrates the chromaticity diagram showing the neutral white color obtained by combining a cyanish-tinted white state produced by the first portion of the display element with a yellowish-tinted native white state produced by the second portion of the display element using spatial and/or temporal dithering.

FIGS. 11D-1 and 11D-2 illustrate different implementations of a display element, each implementation including a first portion configured to produce a tinted native white state and a second portion configured to produce a native white state with a complementary tint such that the implementations of the display element are capable of achieving a neutral white color that is perceptually similar to a D65 white point.

FIG. 12A is a flowchart that illustrates an example of a method of achieving a neutral white color of a display element. FIG. 12B is a flowchart that illustrates an example of a method of achieving a neutral white color of a display device including at least a first and a second display element.

FIG. 13A illustrates an implementation of a display device including a curved reflector. FIG. 13B depicts the curvature of the reflector across the surface of the reflector.

FIG. 14A shows a perspective top view of an implementation of a movable reflector of display device including a plurality of hinges. FIG. 14B shows a perspective bottom view of the movable reflector depicted in FIG. 14A.

FIG. 15 illustrates the variation of color distance to D65 white color coordinates in Lab color space and xy color space as a function of curvature of the movable reflector for different configurations of the display device.

FIG. 16 illustrates the variation of luminance as a function of curvature of the movable reflector for different configurations of the display device.

FIGS. 17A and 17B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Various systems and methods described herein can be used to achieve a neutral white color of an EMS display device. For example, various implementations of a display device described herein are configured to display a tinted white state different from a standard white point (e.g., a D65 white point). In such implementations, the display device is configured to display a neutral white (e.g., a D65 white point) by combining the tinted native white state with a complementary primary color using spatial and/or temporal dithering. The display device is configured such that the tinted white state and the complementary primary color have a brightness level greater than a threshold. For example, the complementary primary color has a luminance (Y) that is at least 30% of the luminance of the tinted native white state when it is measured along the specular direction without front screen optics. Additionally, the display device is configured such that a contrast ratio between the tinted native white state and the complementary color is less than a threshold contrast ratio. Without any loss of generality, the term “white color” can be used interchangeably with the term “white state.”

As another example, various implementations of a display device described herein comprise a first display element and a second display element disposed adjacent to each other. The first display element is configured to produce a first tinted native white state and the second display element is configured to produce a second tinted native white state. The tints of the first and the second tinted native white states can be complementary to each other. A neutral white color can be produced by combining the first and the second tinted native white states by spatial dithering. The first and second display elements can be configured such that the first and second native white states have a brightness level greater than a threshold brightness level and a contrast ratio less than a threshold contrast ratio. As another example, in various implementations of display devices described herein, the display device comprises a display element including a first optical cavity and a second optical cavity. The first optical cavity is configured to produce a first tinted native white state and the second optical cavity is configured to produce a second tinted native white state. As discussed above, the first and the second tinted native white states can be complementary to each other and have a brightness level greater than a threshold brightness level and a contrast ratio less than a threshold contrast ratio. A neutral white color can be produced by combining the first and the second white states. In various implementations, the movable reflector can be configured to be curved such that a central portion of the display device produces a tinted white state and a peripheral portion of the display device produces a bright complementary color or a complementary tinted white state such that the native white state of the display device is a combination of the tinted white state and the bright complementary color or the complementary tinted white state.

The subject matter described in this disclosure can be implemented in various ways to realize one or more of the following potential advantages. Optical stacks in EMS devices that can produce a native white state perceptually similar to D65 white may be complex and/or may have additional processing/material requirements. This may lead to an increase in manufacturing complexity and costs. Various implementations of EMS devices that are configured to have a native white state perceptually similar to D65 white may produce a greenish-tinted native state. To achieve a neutral white color, the greenish-tinted native white state can be spatially/temporally dithered with two color primaries—blue and red, or a single primary—magenta. Blue, red and magenta are relatively dark colors and have a high contrast with respect to the greenish-tinted native white state. Accordingly, a neutral white color obtained by spatially/temporally dithering a greenish-tinted native white state with blue, red or magenta color primaries can exhibit large dithering noise and may also have a reduced brightness.

In the implementations described herein, the display devices are configured such that a contrast ratio between the native white state and the complementary primary color or a contrast ratio between the native white state and the complementary native white state native is reduced, e.g. less than a threshold value. Additionally, the display devices are configured such that the native white state and the complementary primary color or the complementary native white state have a brightness level that is increase, e.g., greater than a threshold brightness level. Accordingly, the neutral white color generated by combining the native white state with the complementary primary color or the complementary native white state can be advantageously close to the desired standard white (e.g., D65) and have a brightness level greater than a threshold level. Additionally, optical stacks of EMS devices that have a native white state that is tinted can be less complex which may result in reduced manufacturing costs and complexity.

Various implementations of devices described herein that include two optical resonant cavities configured to produce complementary white states can advantageously produce a neutral white color without spatially or temporally mixing color displayed by other pixels. This can further advantageously reduce the complexity of the device driving schemes since a single drive signal can be used to drive the two optical cavities and produce a neutral white color.

Various implementations of devices described herein that include two optical resonant cavities configured to produce complementary-tinted white states can advantageously produce a neutral white color without spatially or temporally mixing color displayed by other pixels. This can further advantageously reduce the complexity of the device driving schemes since a single drive signal can be used to drive the two optical cavities and produce a neutral white color. Additionally, the color performance including the neutral white color may be more tolerant to variations in the thicknesses of the various layers of the optical stack in implementations of EMS devices including two optical resonant cavities that are configured to produce complementary-tinted white states.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

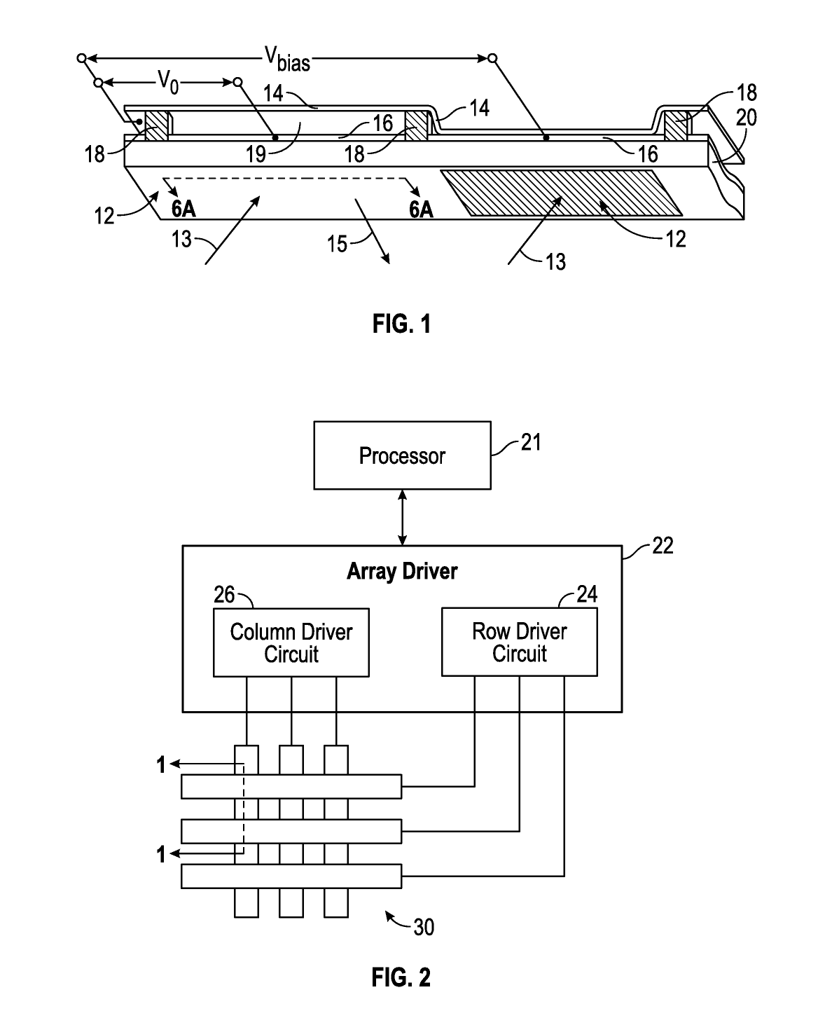

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage Vbias applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V0 applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

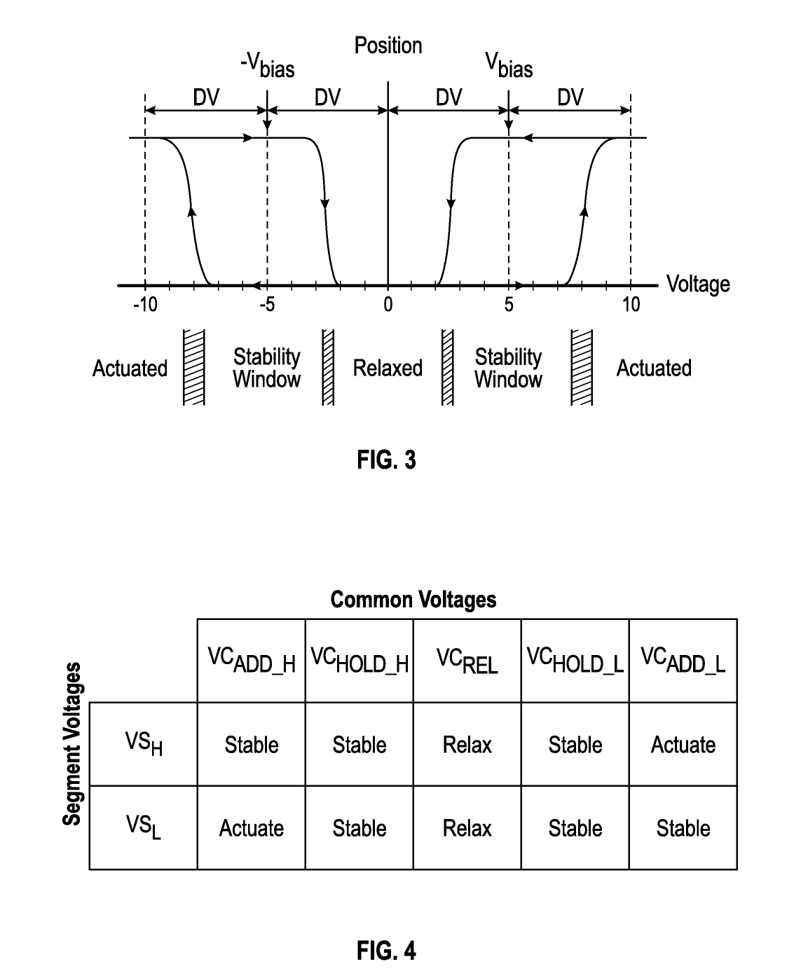

FIG. 3 is a graph illustrating movable reflective layer position versus applied voltage for an IMOD display element. For IMODs, the row/column (i.e., common/segment) write procedure may take advantage of a hysteresis property of the display elements as illustrated in FIG. 3. An IMOD display element may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3-7 volts, in the example of FIG. 3, exists where there is a window of applied voltage within which the element is stable in either the relaxed or actuated state. This is referred to herein as the “hysteresis window” or “stability window.” For a display array 30 having the hysteresis characteristics of FIG. 3, the row/column write procedure can be designed to address one or more rows at a time. Thus, in this example, during the addressing of a given row, display elements that are to be actuated in the addressed row can be exposed to a voltage difference of about 10 volts, and display elements that are to be relaxed can be exposed to a voltage difference of near zero volts. After addressing, the display elements can be exposed to a steady state or bias voltage difference of approximately 5 volts in this example, such that they remain in the previously strobed, or written, state. In this example, after being addressed, each display element sees a potential difference within the “stability window” of about 3-7 volts. This hysteresis property feature enables the IMOD display element design to remain stable in either an actuated or relaxed pre-existing state under the same applied voltage conditions. Since each IMOD display element, whether in the actuated or relaxed state, can serve as a capacitor formed by the fixed and moving reflective layers, this stable state can be held at a steady voltage within the hysteresis window without substantially consuming or losing power. Moreover, essentially little or no current flows into the display element if the applied voltage potential remains substantially fixed.

In some implementations, a frame of an image may be created by applying data signals in the form of “segment” voltages along the set of column electrodes, in accordance with the desired change (if any) to the state of the display elements in a given row. Each row of the array can be addressed in turn, such that the frame is written one row at a time. To write the desired data to the display elements in a first row, segment voltages corresponding to the desired state of the display elements in the first row can be applied on the column electrodes, and a first row pulse in the form of a specific “common” voltage or signal can be applied to the first row electrode. The set of segment voltages can then be changed to correspond to the desired change (if any) to the state of the display elements in the second row, and a second common voltage can be applied to the second row electrode. In some implementations, the display elements in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each display element (that is, the potential difference across each display element or pixel) determines the resulting state of each display element. FIG. 4 is a table illustrating various states of an IMOD display element when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

As illustrated in FIG. 4, when a release voltage VCREL is applied along a common line, all IMOD display elements along the common line will be placed in a relaxed state, alternatively referred to as a released or unactuated state, regardless of the voltage applied along the segment lines, i.e., high segment voltage VSH and low segment voltage VSL. In particular, when the release voltage VCREL is applied along a common line, the potential voltage across the modulator display elements or pixels (alternatively referred to as a display element or pixel voltage) can be within the relaxation window (see FIG. 3, also referred to as a release window) both when the high segment voltage VSH and the low segment voltage VSL are applied along the corresponding segment line for that display element.

When a hold voltage is applied on a common line, such as a high hold voltage VCHOLD_H or a low hold voltage VCHOLD_L, the state of the IMOD display element along that common line will remain constant. For example, a relaxed IMOD display element will remain in a relaxed position, and an actuated IMOD display element will remain in an actuated position. The hold voltages can be selected such that the display element voltage will remain within a stability window both when the high segment voltage VSH and the low segment voltage VSL are applied along the corresponding segment line. Thus, the segment voltage swing in this example is the difference between the high VSH and low segment voltage VSL, and is less than the width of either the positive or the negative stability window.

When an addressing, or actuation, voltage is applied on a common line, such as a high addressing voltage VCADD_H or a low addressing voltage VCADD_L, data can be selectively written to the modulators along that common line by application of segment voltages along the respective segment lines. The segment voltages may be selected such that actuation is dependent upon the segment voltage applied. When an addressing voltage is applied along a common line, application of one segment voltage will result in a display element voltage within a stability window, causing the display element to remain unactuated. In contrast, application of the other segment voltage will result in a display element voltage beyond the stability window, resulting in actuation of the display element. The particular segment voltage which causes actuation can vary depending upon which addressing voltage is used. In some implementations, when the high addressing voltage VCADD_H is applied along the common line, application of the high segment voltage VSH can cause a modulator to remain in its current position, while application of the low segment voltage VSL can cause actuation of the modulator. As a corollary, the effect of the segment voltages can be the opposite when a low addressing voltage VCADD_L is applied, with high segment voltage VSH causing actuation of the modulator, and low segment voltage VSL having substantially no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation that could occur after repeated write operations of a single polarity.

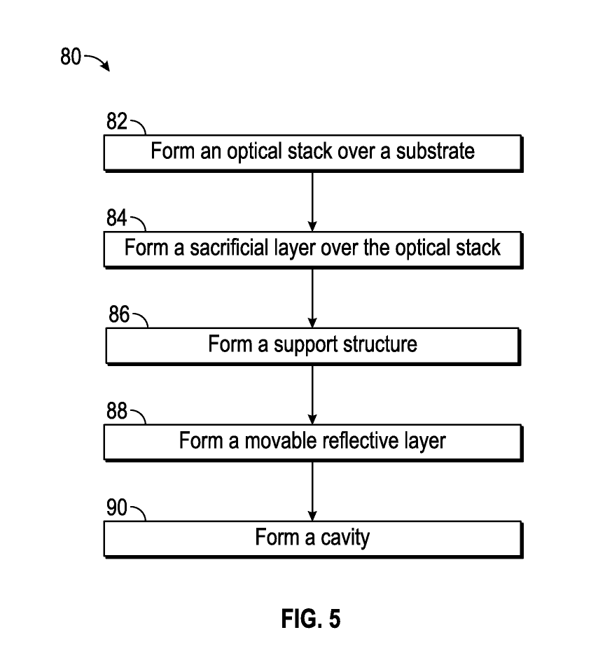

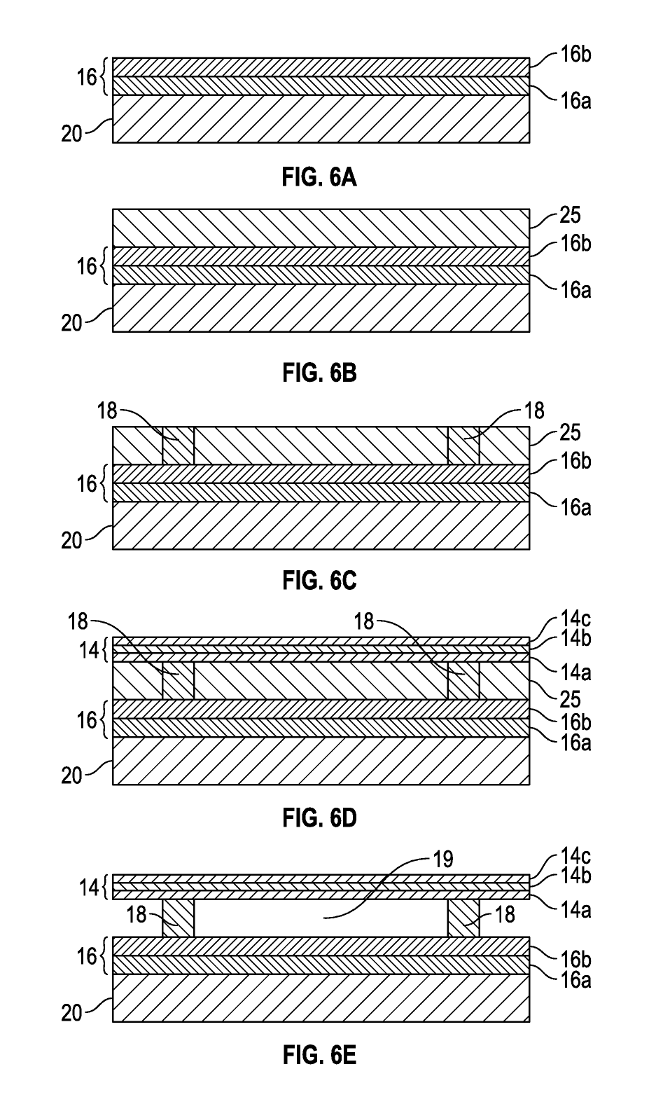

FIG. 5 is a flow diagram illustrating a manufacturing process 80 for an IMOD display or display element. FIGS. 6A-6E are cross-sectional illustrations of various stages in the manufacturing process 80 for making an IMOD display or display element. In some implementations, the manufacturing process 80 can be implemented to manufacture one or more EMS devices, such as IMOD displays or display elements. The manufacture of such an EMS device also can include other blocks not shown in FIG. 5. The process 80 begins at block 82 with the formation of the optical stack 16 over the substrate 20. FIG. 6A illustrates such an optical stack 16 formed over the substrate 20. The substrate 20 may be a transparent substrate such as glass or plastic such as the materials discussed above with respect to FIG. 1. The substrate 20 may be flexible or relatively stiff and unbending, and may have been subjected to prior preparation processes, such as cleaning, to facilitate efficient formation of the optical stack 16. As discussed above, the optical stack 16 can be electrically conductive, partially transparent, partially reflective, and partially absorptive, and may be fabricated, for example, by depositing one or more layers having the desired properties onto the transparent substrate 20.

In FIG. 6A, the optical stack 16 includes a multilayer structure having sub-layers 16a and 16b, although more or fewer sub-layers may be included in some other implementations. In some implementations, one of the sub-layers 16a and 16b can be configured with both optically absorptive and electrically conductive properties, such as the combined conductor/absorber sub-layer 16a. In some implementations, one of the sub-layers 16a and 16b can include molybdenum-chromium (molychrome or MoCr), or other materials with a suitable complex refractive index. Additionally, one or more of the sub-layers 16a and 16b can be patterned into parallel strips, and may form row electrodes in a display device. Such patterning can be performed by a masking and etching process or another suitable process known in the art. In some implementations, one of the sub-layers 16a and 16b can be an insulating or dielectric layer, such as an upper sub-layer 16b that is deposited over one or more underlying metal and/or oxide layers (such as one or more reflective and/or conductive layers). In addition, the optical stack 16 can be patterned into individual and parallel strips that form the rows of the display. In some implementations, at least one of the sub-layers of the optical stack, such as the optically absorptive layer, may be quite thin (e.g., relative to other layers depicted in this disclosure), even though the sub-layers 16a and 16b are shown somewhat thick in FIGS. 6A-6E.

The process 80 continues at block 84 with the formation of a sacrificial layer 25 over the optical stack 16. Because the sacrificial layer 25 is later removed (see block 90) to form the cavity 19, the sacrificial layer 25 is not shown in the resulting IMOD display elements. FIG. 6B illustrates a partially fabricated device including a sacrificial layer 25 formed over the optical stack 16. The formation of the sacrificial layer 25 over the optical stack 16 may include deposition of a xenon difluoride (XeF2)-etchable material such as molybdenum (Mo) or amorphous silicon (Si), in a thickness selected to provide, after subsequent removal, a gap or cavity 19 (see also FIG. 6E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as a support post 18. The formation of the support post 18 may include patterning the sacrificial layer 25 to form a support structure aperture, then depositing a material (such as a polymer or an inorganic material, like silicon oxide) into the aperture to form the support post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the support post 18 contacts the substrate 20. Alternatively, as depicted in FIG. 6C, the aperture formed in the sacrificial layer 25 can extend through the sacrificial layer 25, but not through the optical stack 16. For example, FIG. 6E illustrates the lower ends of the support posts 18 in contact with an upper surface of the optical stack 16. The support post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 6C, but also can extend at least partially over a portion of the sacrificial layer 25. As noted above, the patterning of the sacrificial layer 25 and/or the support posts 18 can be performed by a masking and etching process, but also may be performed by alternative patterning methods.

The process 80 continues at block 88 with the formation of a movable reflective layer or membrane such as the movable reflective layer 14 illustrated in FIG. 6D. The movable reflective layer 14 may be formed by employing one or more deposition steps, including, for example, reflective layer (such as aluminum, aluminum alloy, or other reflective materials) deposition, along with one or more patterning, masking and/or etching steps. The movable reflective layer 14 can be patterned into individual and parallel strips that form, for example, the columns of the display. The movable reflective layer 14 can be electrically conductive, and referred to as an electrically conductive layer. In some implementations, the movable reflective layer 14 may include a plurality of sub-layers 14a, 14b and 14c as shown in FIG. 6D. In some implementations, one or more of the sub-layers, such as sub-layers 14a and 14c, may include highly reflective sub-layers selected for their optical properties, and another sub-layer 14b may include a mechanical sub-layer selected for its mechanical properties. In some implementations, the mechanical sub-layer may include a dielectric material. Since the sacrificial layer 25 is still present in the partially fabricated IMOD display element formed at block 88, the movable reflective layer 14 is typically not movable at this stage. A partially fabricated IMOD display element that contains a sacrificial layer 25 also may be referred to herein as an “unreleased” IMOD.

The process 80 continues at block 90 with the formation of a cavity 19. The cavity 19 may be formed by exposing the sacrificial material 25 (deposited at block 84) to an etchant. For example, an etchable sacrificial material such as Mo or amorphous Si may be removed by dry chemical etching by exposing the sacrificial layer 25 to a gaseous or vaporous etchant, such as vapors derived from solid XeF2 for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD display element may be referred to herein as a “released” IMOD.

In some implementations, the packaging of an EMS component or device, such as an IMOD-based display, can include a backplate (alternatively referred to as a backplane, back glass or recessed glass) which can be configured to protect the EMS components from damage (such as from mechanical interference or potentially damaging substances). The backplate also can provide structural support for a wide range of components, including but not limited to driver circuitry, processors, memory, interconnect arrays, vapor barriers, product housing, and the like. In some implementations, the use of a backplate can facilitate integration of components and thereby reduce the volume, weight, and/or manufacturing costs of a portable electronic device.

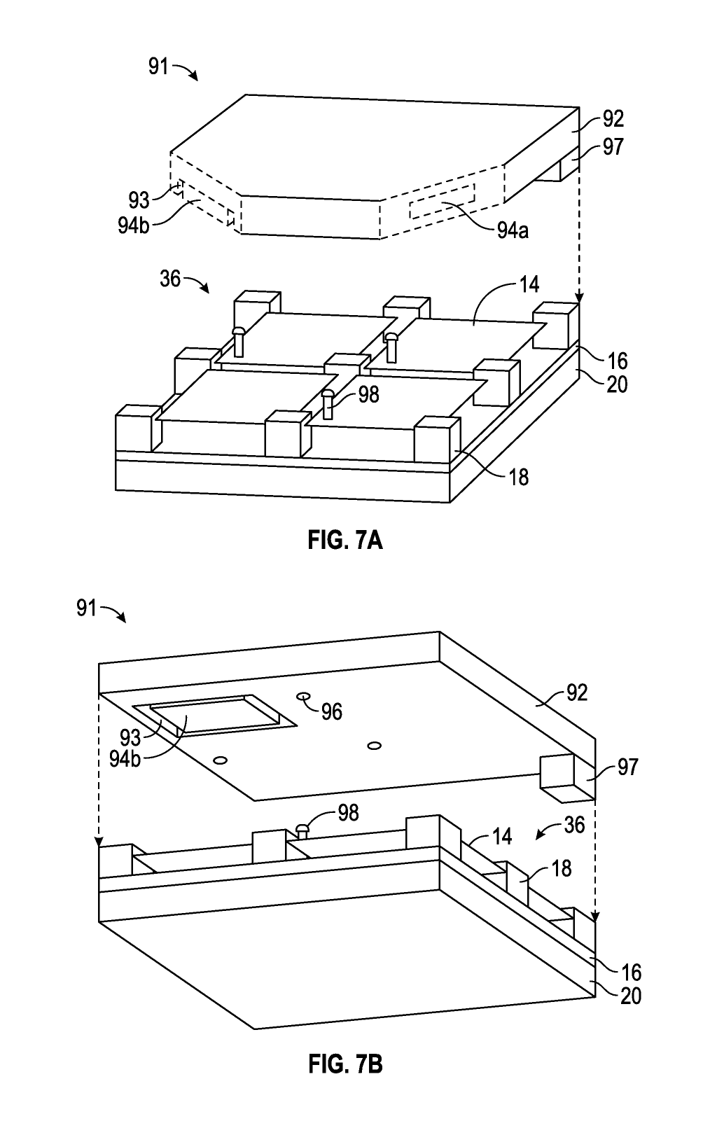

FIGS. 7A and 7B are schematic exploded partial perspective views of a portion of an EMS package 91 including an array 36 of EMS elements and a backplate 92. FIG. 7A is shown with two corners of the backplate 92 cut away to better illustrate certain portions of the backplate 92, while FIG. 7B is shown without the corners cut away. The EMS array 36 can include a substrate 20, support posts 18, and a movable layer 14. In some implementations, the EMS array 36 can include an array of IMOD display elements with one or more optical stack portions 16 on a transparent substrate, and the movable layer 14 can be implemented as a movable reflective layer.

The backplate 92 can be essentially planar or can have at least one contoured surface (e.g., the backplate 92 can be formed with recesses and/or protrusions). The backplate 92 may be made of any suitable material, whether transparent or opaque, conductive or insulating. Suitable materials for the backplate 92 include, but are not limited to, glass, plastic, ceramics, polymers, laminates, metals, metal foils, Kovar and plated Kovar.

As shown in FIGS. 7A and 7B, the backplate 92 can include one or more backplate components 94a and 94b, which can be partially or wholly embedded in the backplate 92. As can be seen in FIG. 7A, backplate component 94a is embedded in the backplate 92. As can be seen in FIGS. 7A and 7B, backplate component 94b is disposed within a recess 93 formed in a surface of the backplate 92. In some implementations, the backplate components 94a and/or 94b can protrude from a surface of the backplate 92. Although backplate component 94b is disposed on the side of the backplate 92 facing the substrate 20, in other implementations, the backplate components can be disposed on the opposite side of the backplate 92.

The backplate components 94a and/or 94b can include one or more active or passive electrical components, such as transistors, capacitors, inductors, resistors, diodes, switches, and/or integrated circuits (ICs) such as a packaged, standard or discrete IC. Other examples of backplate components that can be used in various implementations include antennas, batteries, and sensors such as electrical, touch, optical, or chemical sensors, or thin-film deposited devices.

In some implementations, the backplate components 94a and/or 94b can be in electrical communication with portions of the EMS array 36. Conductive structures such as traces, bumps, posts, or vias may be formed on one or both of the backplate 92 or the substrate 20 and may contact one another or other conductive components to form electrical connections between the EMS array 36 and the backplate components 94a and/or 94b. For example, FIG. 7B includes one or more conductive vias 96 on the backplate 92 which can be aligned with electrical contacts 98 extending upward from the movable layers 14 within the EMS array 36. In some implementations, the backplate 92 also can include one or more insulating layers that electrically insulate the backplate components 94a and/or 94b from other components of the EMS array 36. In some implementations in which the backplate 92 is formed from vapor-permeable materials, an interior surface of backplate 92 can be coated with a vapor barrier (not shown).

The backplate components 94a and 94b can include one or more desiccants which act to absorb any moisture that may enter the EMS package 91. In some implementations, a desiccant (or other moisture absorbing materials, such as a getter) may be provided separately from any other backplate components, for example as a sheet that is mounted to the backplate 92 (or in a recess formed therein) with adhesive. Alternatively, the desiccant may be integrated into the backplate 92. In some other implementations, the desiccant may be applied directly or indirectly over other backplate components, for example by spray-coating, screen printing, or any other suitable method.

In some implementations, the EMS array 36 and/or the backplate 92 can include mechanical standoffs 97 to maintain a distance between the backplate components and the display elements and thereby prevent mechanical interference between those components. In the implementation illustrated in FIGS. 7A and 7B, the mechanical standoffs 97 are formed as posts protruding from the backplate 92 in alignment with the support posts 18 of the EMS array 36. Alternatively or in addition, mechanical standoffs, such as rails or posts, can be provided along the edges of the EMS package 91.

Although not illustrated in FIGS. 7A and 7B, a seal can be provided which partially or completely encircles the EMS array 36. Together with the backplate 92 and the substrate 20, the seal can form a protective cavity enclosing the EMS array 36. The seal may be a semi-hermetic seal, such as a conventional epoxy-based adhesive. In some other implementations, the seal may be a hermetic seal, such as a thin film metal weld or a glass frit. In some other implementations, the seal may include polyisobutylene (PIB), polyurethane, liquid spin-on glass, solder, polymers, plastics, or other materials. In some implementations, a reinforced sealant can be used to form mechanical standoffs.

In alternate implementations, a seal ring may include an extension of either one or both of the backplate 92 or the substrate 20. For example, the seal ring may include a mechanical extension (not shown) of the backplate 92. In some implementations, the seal ring may include a separate member, such as an O-ring or other annular member.

In some implementations, the EMS array 36 and the backplate 92 are separately formed before being attached or coupled together. For example, the edge of the substrate 20 can be attached and sealed to the edge of the backplate 92 as discussed above. Alternatively, the EMS array 36 and the backplate 92 can be formed and joined together as the EMS package 91. In some other implementations, the EMS package 91 can be fabricated in any other suitable manner, such as by forming components of the backplate 92 over the EMS array 36 by deposition.

Various implementations of a multi-primary display device can include the EMS array 36. The EMS elements in the array can include one or more IMODs. In some implementations the IMOD can include an analog IMOD (AIMOD). The AIMOD may be configured to selectively reflect multiple primary colors and provide 1 bit per color.

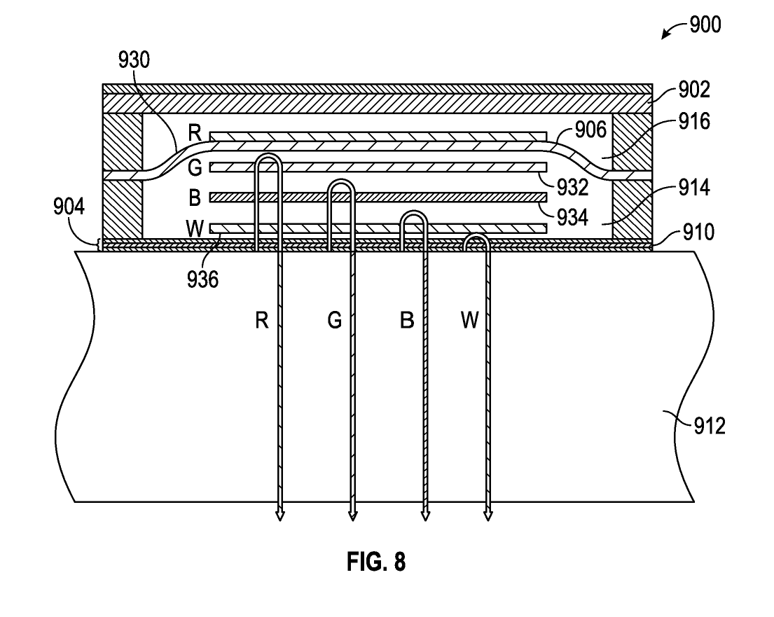

FIG. 8 shows a cross-section of an implementation of an AIMOD. The AIMOD 900 includes a substrate 912 and an optical stack 904 disposed over the substrate 912. The AIMOD includes a first electrode 910 and a second electrode 902 (as illustrated, the first electrode 910 is a lower electrode, and second electrode 902 is an upper electrode). The AIMOD 900 also includes a movable reflective layer 906 disposed between the first electrode 910 and the second electrode 902. In some implementations, the optical stack 904 includes an absorbing layer, and/or a plurality of other layers. In some implementations, and in the example illustrated in FIG. 8, the optical stack 904 includes the first electrode 910 which is configured as an absorbing layer. In such a configuration, the absorbing layer (first electrode 910) can be an approximately 6 nm layer of material that includes MoCr. In some implementations, the absorbing layer (that is, the first electrode 910) can be a layer of material including MoCr with a thickness ranging from approximately 2 nm to 50 nm.

The reflective layer 906 can be actuated toward either the first electrode 910 or the second electrode 902 when a voltage is applied between the first and second electrodes 910 and 902. In this manner, the reflective layer 906 can be driven through a range of positions between the two electrodes 902 and 910, including above and below a relaxed (unactuated) state. For example, FIG. 8 illustrates that the reflective layer 906 can be moved to various positions 930, 932, 934 and 936 between the first electrode 910 and the second electrode 902.

The AIMOD 900 in FIG. 8 has two structural cavities, a first cavity 914 between the reflective layer 906 and the optical stack 904, and a second cavity 916 between the reflective layer 906 and the second electrode 902. In various implementations, the first cavity 914 and/or the second cavity can include air. The color and/or intensity of light reflected by the AIMOD 900 is determined by the distance between the reflective layer 906 and the absorbing layer (first electrode 910).

The AIMOD 900 can be configured to selectively reflect certain wavelengths of light depending on the configuration of the AIMOD. The distance between the first electrode 910, which in this implementation acts as an absorbing layer and the reflective layer 906 changes the reflective properties of the AIMOD 900. Any particular wavelength is maximally reflected from the AIMOD 900 when the distance between the reflective layer 906 and the absorbing layer (first electrode 910) is such that the absorbing layer (first electrode 910) is located at the minimum light intensity of standing waves resulting from interference between incident light and light reflected from the reflective layer 906. For example, as illustrated, the AIMOD 900 is designed to be viewed from the substrate 912 side of the AIMOD (through the substrate 912), that is, light enters the AIMOD 900 through the substrate 912. Depending on the position of the reflective layer 906, different wavelengths of light are reflected back through the substrate 912, which gives the appearance of different colors. These different colors are also referred to as native or primary colors. The number of primary colors produced by the AIMOD 900 can be greater than 4. For example, the number of primary colors produced by the AIMOD 900 can be 5, 6, 8, 10, 16, 18, 33, etc.

A position of the movable layer 906 at a location such that it reflects a certain wavelength or wavelengths can be referred to as a display state of the AIMOD 900. For example, when the reflective layer 906 is in position 930, red wavelengths of light are reflected in greater proportion than other wavelengths and the other wavelengths of light are absorbed in greater proportion than red. Accordingly, the AIMOD 900 appears red and is said to be in a red display state, or simply a red state. Similarly, the AIMOD 900 is in a green display state (or green state) when the reflective layer 906 moves to position 932, where green wavelengths of light are reflected in greater proportion than other wavelengths and the other wavelengths of light are absorbed in greater proportion than green. When the reflective layer 906 moves to position 934, the AIMOD 900 is in a blue display state (or blue state) and blue wavelengths of light are reflected in greater proportion than other wavelengths and the other wavelengths of light are absorbed in greater proportion than blue. When the reflective layer 906 moves to a position 936, the AIMOD 900 is in a white display state (or white state) and a broad range of wavelengths of light in the visible spectrum are substantially reflected such that the AIMOD 900 appears “gray” or in some cases “silver,” and having low total reflection (or luminance) when a bare metal reflector is used. In some cases increased total reflection (or luminance) can be achieved with the addition of dielectric layers disposed on the metal reflector, but the reflected color may be tinted with blue, green or yellow, depending on the exact position of 936. In some implementations, in position 936, configured to produce a white state, the distance between the reflective layer 906 and the first electrode 910 is between about 0 and 20 nm. In other implementations, the AIMOD 900 can take on different states and selectively reflect other wavelengths of light based on the position of the reflective layer 906, and also based on materials that are used in construction of the AIMOD 900, particularly various layers in the optical stack 904.

In various implementations, the AIMOD 900 displays white color (also referred to as the “white state”) when different wavelengths in the visible spectral range are reflected in approximately equal amounts. Without subscribing to any theory, the white state occurs when the null of the standing waves for red, green and blue wavelengths occurs at the absorber included in the optical stack 904. However, in some implementations of the AIMOD 900, the null of the standing waves for red, green and blue wavelengths may not spatially coincide at the absorber included in the optical stack 904. For example, in some implementations, the null for the green wavelength may occur at the absorber included in the optical stack 904, but the null for the red and blue wavelengths may occur above or below the absorber included in the optical stack 904 resulting in electric field intensity for red and blue wavelengths being greater at the absorber included in the optical stack 904 as compared to the electric field intensity for green wavelength. In such implementations, red and blue wavelengths may be absorbed in a larger amount by the absorber included in the optical stack 904 than the green wavelength resulting in a green-tinted native white state instead of an industry-standard white, such as CIE Standard Illuminant D65 white. In such systems, the neutral white color can be obtained by combining the green-tinted native white state with a complementary color (e.g., magenta) using spatial and/or temporal dithering methods. However, since the color that is complementary to the green-tinted native white state is darker, the resulting white state can have decreased brightness. Additionally, since the contrast ratio between a green-tinted native white state and the complementary color (e.g., magenta) that results in the neutral white color can be high, the dither noise produced when combining green-tinted native white state and the complementary color using spatial and/or temporal dithering methods can be visible.

Systems and methods described herein are directed towards configuring the display element to produce a neutral white color which, when combined with a complementary primary color or a complementary native white state, results in a neutral white color that is bright. Furthermore, the display element is configured such that a contrast ratio between the native white state and the complementary primary color or a complementary native white state is less than a threshold contrast ratio such that the dither noise produced when combining the native white state and the complementary primary color or a complementary native white state using spatial and/or temporal dithering methods is less visible.

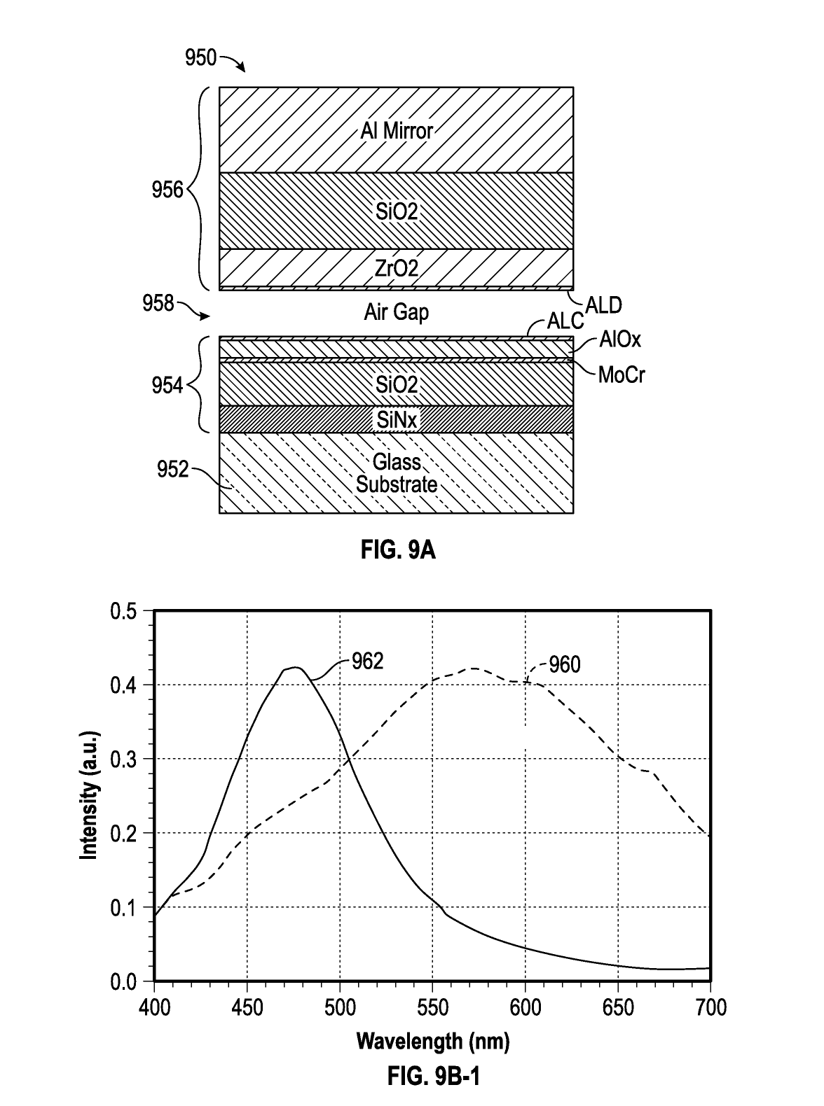

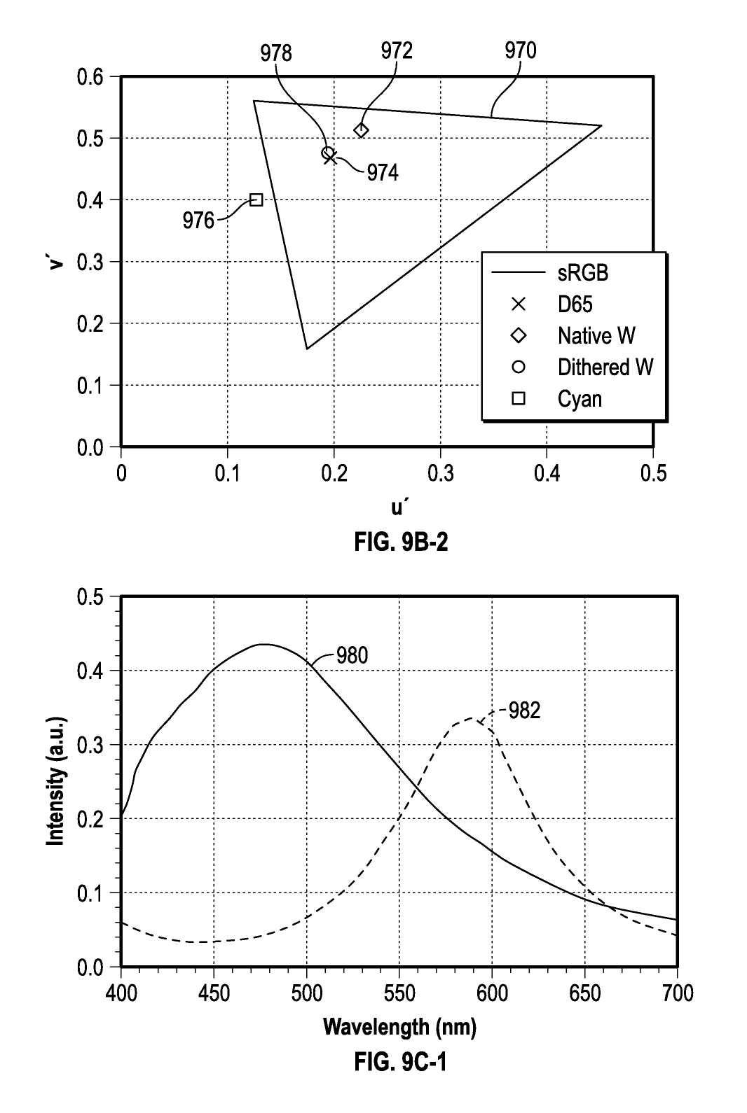

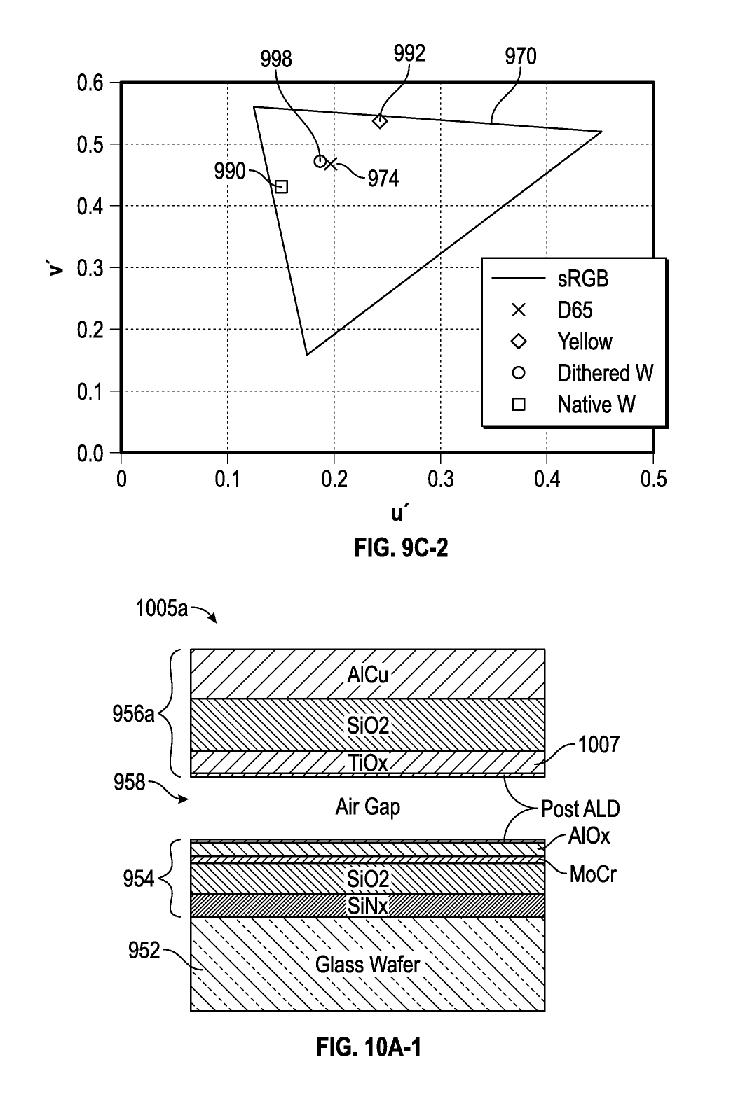

FIG. 9A illustrates an implementation of an EMS display element 950 that is configured to produce a bright tinted native white state and a complementary primary color that is also bright and has a low contrast ratio with respect to the tinted native white state that results in a neutral white color when combined with the tinted native white state. The EMS based display element 950 includes an optical stack 954 disposed on a substrate 952 and a movable reflector 956 spaced apart from the optical stack 954 by a gap 958. The substrate 952 can include glass or other transmissive material. The optical stack 954 can include a partial absorber (e.g., a layer of MoCr with an aluminum oxide passivation). The movable reflector 956 can include a metal reflector (e.g., aluminum). The gap 958 can include air and/or a deformable dielectric. The display element 950 is configured to produce a yellowish-tinted native white state when the movable reflector 956 is driven to the down state in response to voltages applied by a driver (e.g., array driver 22, driver circuits 24 and/or 26, etc.). In some implementations, the height of the gap 958 in the down state can be about 10 nm. Without any loss of generality, the yellowish native white state can be characterized by a color temperature between about 3000 K and about 5400K. To generate a white state that is close to the D65 white point, the yellowish-tinted native white state can be spatially and/or temporally dithered with a cyan primary color which can be produced by changing the height of the gap 958. For example, the movable reflector 956 of the same display element or another display element can be driven to a state where the display element displays a cyan primary color by the driver (e.g., array driver 22, driver circuits 24 and/or 26, etc.). A display element can be configured to display the cyan primary color by appropriately selecting the driving voltages to place the movable reflector 956 at a desired position to achieve a desired height of the gap 958. A neutral white color is produced by combining the cyan primary color with the yellowish-tinted native white state using spatial and/or temporal dithering. Furthermore, since the contrast ratio of the yellowish-tinted native white state and the cyan primary color is less than a threshold contrast ratio, the white state produced has lower visible dither noise.

One example of the white state achieved by dithering yellowish-tinted white state with the cyan primary color for an implementation of the display element 950 was determined through simulations. FIG. 9B-1 shows the simulated reflectance spectrum of the yellowish-tinted native white state represented by curve 960 and a cyan primary color represented by curve 962 for an implementation of a display element 950. The yellowish-tinted native white state has an intensity peak between about 550 nm and 600 nm as observed from the spectrum 960. The cyan primary color has an intensity peak at about 480 nm as observed from the spectrum 962. It is further observed that the yellowish-tinted native white state has a broad reflectance spectrum indicating that yellowish-tinted native white state is bright while the cyan primary color has a narrower reflectance spectrum as compared to the reflectance spectrum of the yellowish-tinted native white state.

FIG. 9B-2 is a chromaticity diagram showing the simulated dithered white point 978 achieved by spatially and/or temporally dithering the yellowish-tinted native white state 972 with the cyan primary color 976 in the (u′, v′) color space. FIG. 9B-2 also shows the sRGB gamut represented by the curve 970 and the D65 white point represented by point 974. As noted from FIG. 9B-2, the distance between the dithered white point 978 and the D65 white point 974 in the (u′, v′) color space is less than 0.01 indicating that the dithered white point 978 is substantially close to the D65 white point 974.

Table 1 below provides some performance metrics including brightness of the neutral white color (Y) obtained by spatially and/or temporally dithering the yellowish-tinted native white state with the cyan primary color, the distance between the neutral white color and the D65 white point (dR), the contrast ratio between the neutral white color and the black (CR) and the Gamut obtained by simulating an implementation of a display element when illuminated by a D65 source at a d8 configuration (observation at 8 degree angle to the normal of the display with diffused illumination) and indoors configuration (observation at 8 degree angle to the normal with 50% diffused illumination and 50% directed illumination at −20 degree angle to the normal). A haze 78 diffuser with FWHM of ˜20 degree is also assumed in the calculation.

TABLE 1
Simulated performance metrics for an implementation of a display
element having a yellowish-tinted native white state

| | | | Contrast ratio | |
|---|---|---|---|---|
| | | Distance between | between the | |
| | Brightness | the neutral white | neutral white | |
| | of the neutral | color and the | color and the | |
| | white color | D65 white point | dithered black | |
| Illuminant | (Y) | (dR) | (CR) | Gamut |
| d8 | 25% | 0.01 | 18:1 | 55% |
| Indoor | 87% | 0.0096 | 63:1 | 81% |

As noted from the Table 1, the dithered white point obtained by spatially and/or temporally dithering the yellowish-tinted native white state with the cyan primary color in an implementation of a display element 950 is substantially close to the D65 white point when the display element 950 is illuminated by a D65 source under d8 configuration or indoors configuration.

In various implementations, the display element can be configured to produce a cyanish-tinted native white state which can be blended with a yellow primary color by spatial and/or temporal dithering to produce a neutral white color that is substantially close to the D65 white point. Without any loss of generality, the cyanish-tinted native white state can be characterized by a color temperature between about 8500 K and about 20000 K. FIG. 9C-1 shows the simulated reflectance spectrum of the cyanish-tinted native white state represented by curve 980 and a yellow primary color represented by curve 982 for an implementation of a display element. The cyanish-tinted native white state has an intensity peak between about 450 nm and 500 nm as observed from the spectrum 980. The yellow primary color has an intensity peak between about 580 nm and about 590 nm as observed from the spectrum 982. It is further observed that the cyanish-tinted native white state has a broad reflectance spectrum indicating that cyanish-tinted native white state is bright while the yellow primary color has a narrower reflectance spectrum as compared to the reflectance spectrum of the cyanish-tinted native white state. A comparison of FIGS. 9C-1 and 9B-1 shows that the peak intensity of the yellow primary color represented by the spectrum 982 is lower than the peak intensity of the cyan primary color represented by the spectrum 980. Thus, the neutral white color produced by spatially and/or temporally dithering the cyanish-tinted native white state with a yellow primary color can be darker as compared to the neutral white color produced by spatially and/or temporally dithering the yellowish-tinted native white state with a cyan primary color.

FIG. 9C-2 chromaticity diagram showing the simulated dithered white point 998 achieved by spatially and/or temporally dithering the cyanish-tinted native white state 990 with the yellow primary color 992 in the (u′, v′) color space. As observed from FIG. 9C-2, the distance between the neutral white color 998 and the D65 white point 974 is less than a threshold distance of 0.01 in the (u′, v′) color space indicating that the neutral white color 998 is substantially close to the D65 white point.

In this manner a neutral white color can be achieved by combining a bright tinted native white state (e.g., cyanish-tinted or yellowish tinted white state) with a bright complementary primary color (e.g., cyan or yellow) having a brightness level at least 30% of the brightness level of the tinted native white state when it is measured along the specular direction without front screen optics, using spatial and/or temporal dithering. The tint of the native white state is selected such that the contrast ratio between the tinted native white state and the complementary primary color is less than a threshold contrast ratio such that the dither noise is less visible thereby making the display device visually pleasing.

In various implementations, the brightness level of the complementary primary color can be at least between 30% and 35% of the brightness level of the tinted native white state, between 35% and 40% of the brightness level of the tinted native white state or between 45% and 50% of the brightness level of the tinted native white state, all measured along the specular direction without front screen optics.

In some implementations, the brightness of the neutral white color can be lower than the native white when the native white state is combined with a complementary primary color using spatial and/or temporal dithering due to the narrow reflectance spectrum of the complementary primary color. The brightness of the neutral white color can be advantageously increased if the tinted native white state having a broad reflectance spectrum is combined with a native state having a complementary tint color as well as a broad reflectance spectrum. The implementations of display devices described below are directed towards advantageously increasing the brightness of the display white state by combining two complementary tinted native white states both having a broad reflectance spectrum using spatial and/or temporal dithering.

Various implementations of display devices configured to produce a neutral white color by combining a tinted native white state having a broad reflectance spectrum with another native state having a complementary tint color using spatial and/or temporal dithering include at least a first display element adapted to produce the tinted native white state and a second display element adapted to produce the native white state with a complementary tint.

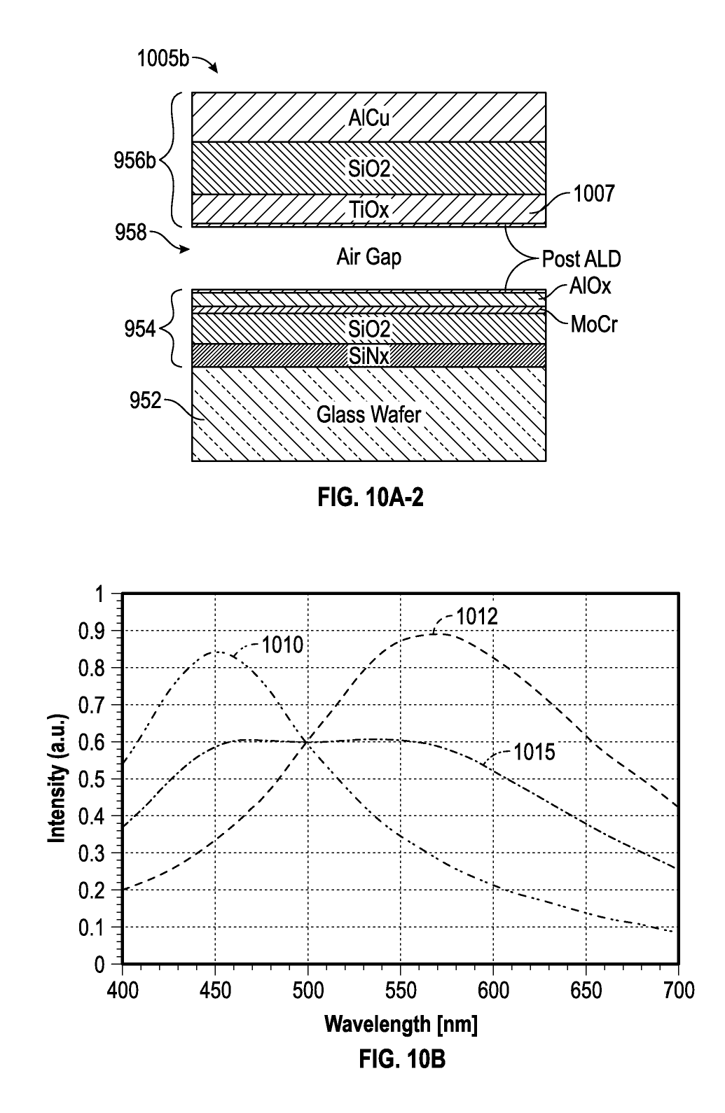

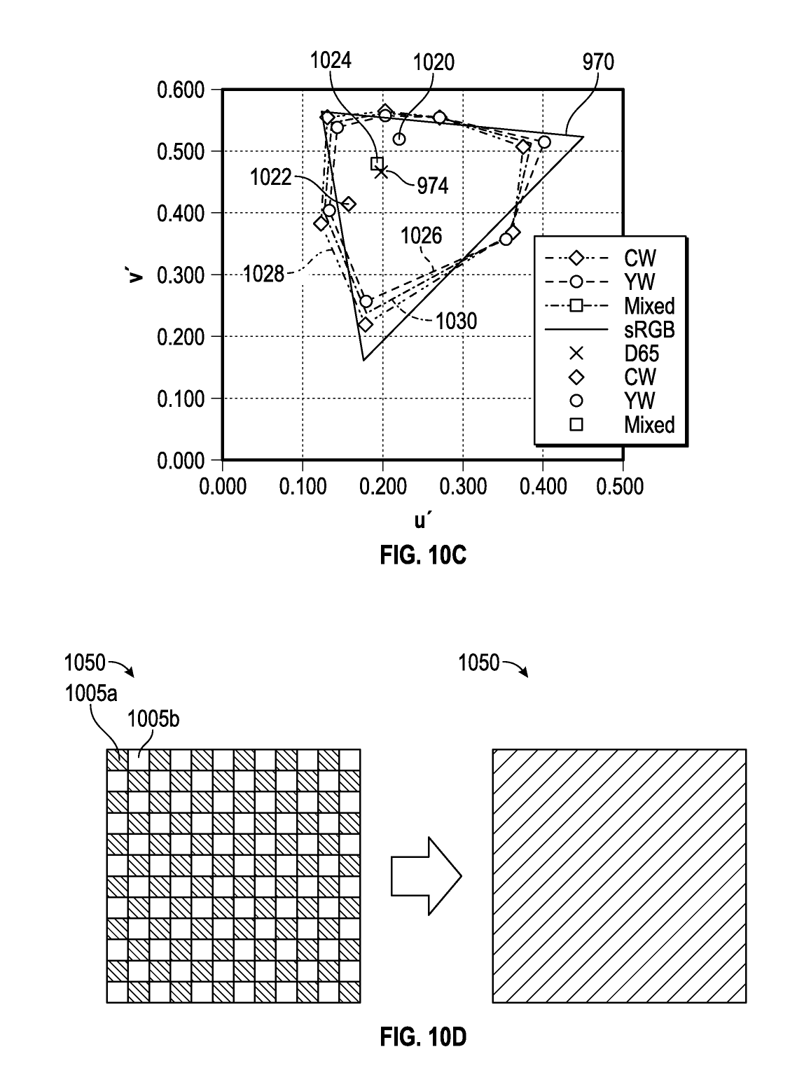

FIG. 10A-1 illustrates an implementation of a first display element 1005a that is adapted to produce a cyanish-tinted white state and FIG. 10A-2 illustrates an implementation of a second display element 1005b that is adapted to produce a yellowish-tinted white state. The first display element 1005a includes a substrate 952, an optical stack 954 disposed over the substrate and a movable reflector 956a spaced apart from the optical stack by a gap 958. The second display element 1005b includes a substrate 952, an optical stack 954 disposed over the substrate and a movable reflector 956b spaced apart from the optical stack by an air gap 958. The movable reflector 956a of the first display element 1005a and the movable reflector 956a of the second display element 1005b each includes a coating layer 1007. By varying a thickness of the coating layer 1007, the display element 1005a and 1005b can be configured to display different tinted white states when the movable reflector 956a and 956b is in the “down state” or when the movable reflector 956a and 956b is closer to the optical stack 954. For the implementations of first and second display elements 1005a and 1005b, a thinner coating layer 1007 produces a cyanish-tinted native white state and a thicker coating layer 1007 produces a yellowish-tinted native white state. In various implementations, the coating layer 1007 can include titanium oxide (TiOx) and have a thickness between about 10 nm and about 50 nm. The composition and the thickness of the coating layers as well as other layers of the movable reflector 956a and 956b and/or the optical stack 954 can be changed to achieve different native white states.

FIG. 10B illustrates the reflectance spectrum 1010 of the first display element 1005a in the down state, the reflectance spectrum 1012 of the second display element 1005b in the down state and the combined reflectance spectrum 1015 produced by spatially and/or temporally dithering the two tinted white states. As discussed above, the first display element 1005a has a cyanish-tinted native white state in the down state. Accordingly, the reflectance spectrum 1010 of the first display element 1005a in the down state when the movable reflector 956a is spaced apart from the optical stack 954 by a distance between about 10 nm-about 20 nm (e.g., when the height of the gap 958 is about 15 nm) has an intensity peak at about 450 nm. It is also noted from FIG. 10B that the first display element 1005a has a broad reflectance spectrum in the down state. For example, the full width at 70%) maximum intensity (FW70M) for the reflectance spectrum 1010 is between about 90 nm-100 nm indicating that the cyanish-tinted native white state is bright.

As discussed above, the second display element 1005b has a yellowish-tinted native white state in the down state. Accordingly, the reflectance spectrum 1012 of the second display element 1005b in the down state when the movable reflector 956b is spaced apart from the optical stack 954 by a distance between about 10 nm-about 20 nm (e.g., when the height of the gap 958 is about 15 nm) has an intensity peak between about 560 nm-about 575 nm. It is also noted from FIG. 10B that the second display element 1005b also has a broad reflectance spectrum in the down state. For example, the full width at 55% maximum intensity (FW55M) for the reflectance spectrum 1012 is between about 190 nm-200 nm indicating that the yellowish-tinted native white state is also bright.

The combined spectrum produced by spatially and/or temporally dithering the cyanish-tinted native white state produced by the first display element 1005a and the yellowish-tinted native white state produced by the second display element 1005b is shown by the spectrum 1015. It is noted from the spectrum 1015 that the combined spectrum has almost uniform intensity in the wavelength range between about 440 nm-about 600 nm indicating that the output produced by spatially and/or temporally dithering the cyanish-tinted native white state produced by the first display element 1005a and the yellowish-tinted native white state produced by the second display element 1005b is a neutral white.

FIG. 10C illustrates the chromaticity diagram showing the neutral white color 1024 obtained by combining a cyanish-tinted white state 1022 with a yellowish-tinted native white state 1020 using spatial and/or temporal dithering. Also shown in FIG. 10C is the D65 white point 974, the sRGB color gamut 970, the color gamut 1028 of the first display element producing a cyanish-tinted white state, a color gamut 1026 of the second display element producing a yellowish-tinted white state and the color gamut 1030 obtained by spatially and/or temporally dithering the colors produced by the first and the second display elements, all with indoor illumination/viewing condition. It is noted that a large portion of the sRGB color gamut 970 is included in the color gamuts 1026, 1028 and 1030 associated with the first and second display elements 1005a and 1005b. For example, in various implementations of the first and second display elements 1005a and 1005b, the color gamut associated with the display elements can be greater than or equal to about 60% of the sRGB color gamut 970 for diffused illumination (d8) and greater than or equal to about 90% of the sRGB color gamut 970 for indoor illumination. Thus, most colors of an input image associated with a sRGB input color gamut can be displayed by the implementations of the first and second display elements with sufficient accuracy.

FIG. 10D illustrates a portion of a display device 1050 including an array of display elements. The array of display elements can include an implementation of the first display element 1005a configured to produce a cyanish-tinted native white state and an implementation of the second display element 1005b configured to produce a yellowish-tinted native white state. In some implementations, the first and second display elements 1005a and 1005b can be arranged in a checker board manner as shown in FIG. 10D. In some implementations, the first and second display elements 1005a and 1005b can be arranged in a different pattern, e.g., a random pattern. The first and the second display elements 1005a and 1005b can each represent an individual pixel of the display device 1050. Alternately, the first display element 1005a can represent a first sub-pixel of a pixel of the display device 1050 and the second display element can represent a second sub-pixel of the pixel of the display device 1050. The display device can be adapted to produce a neutral white color by driving the first and second display elements 1005a and 1005b to the down state such that each of the first display elements 1005a in the array of display elements produce a cyanish-tinted native white state and each of the second display elements 1005b in the array of display elements produce a yellowish-tinted native white state. If the size of the first and the second display elements 1005a and 1005b is sufficiently small, then the brain of an average human will perceive the display device 1050 as a neutral white due to spatial mixing.

While the native white states of the first and second display elements 1005a and 1005b appear to have different tints in the down state, the color level (e.g., tone, grayscale, hue, chroma, saturation, brightness, lightness, luminance, correlated color temperature, dominant wavelength, or color coordinates in a color space) of other device primary colors are not greatly affected by the presence and/or thickness of the coating layer 1007 since the primary colors are mainly determined by the optical distance between the absorber (e.g., MoCr) and the metal reflector (e.g., Al or AlCu). For example, device primary colors having same color levels can be produced by the first and second display elements. However, the height of the air gap 958 that produces the different device primary colors may be different for the first and the second display elements 1005a and 1005b. Table 2 below shows the different air gap heights at which an implementation of the first and the second display elements 1005a and 1005b produce different device primary colors eight different device primary colors including black (K), blue (B), cyan (C), green (G), yellow (Y), orange (0), red (R) and magenta (M).

TABLE 2
Gap heights of the first and second display elements
corresponding to the different primary colors

| | Gap Height of First | Gap Height of Second |
|---|---|---|
| Color | Display Element (nm) | Display Element (nm) |
| Black | 120 | 180 |
| Blue | 189 | 220 |
| Cyan | 237 | 270 |
| Green | 275 | 320 |
| Yellow | 300 | 350 |
| Orange | 320 | 372 |
| Red | 370 | 410 |
| Magenta | 400 | 440 |

In various implementations, the display device can include an array of display elements having a first portion that is configured to produce a native white state with a first tint and second portion that is configured to produce a native white state with a second tint that is complementary to the first tint. In various implementations, the first and the second portions can be included in a single element instead of two separate elements.

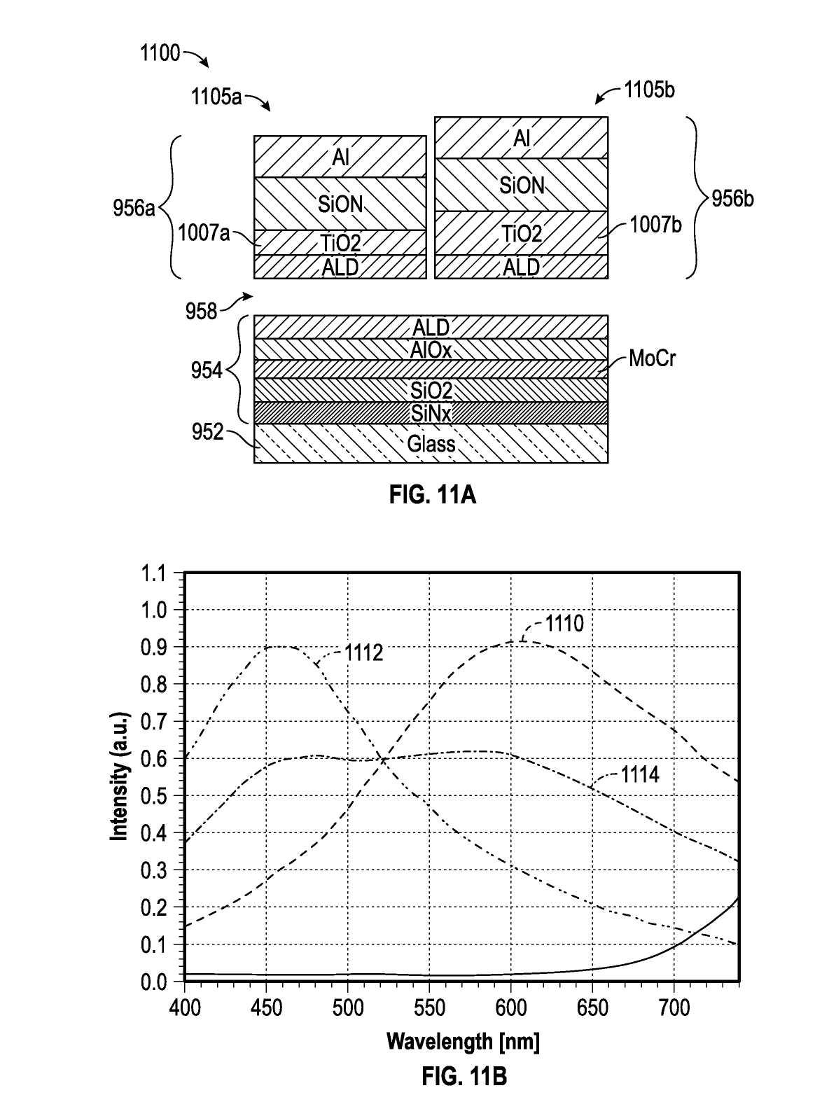

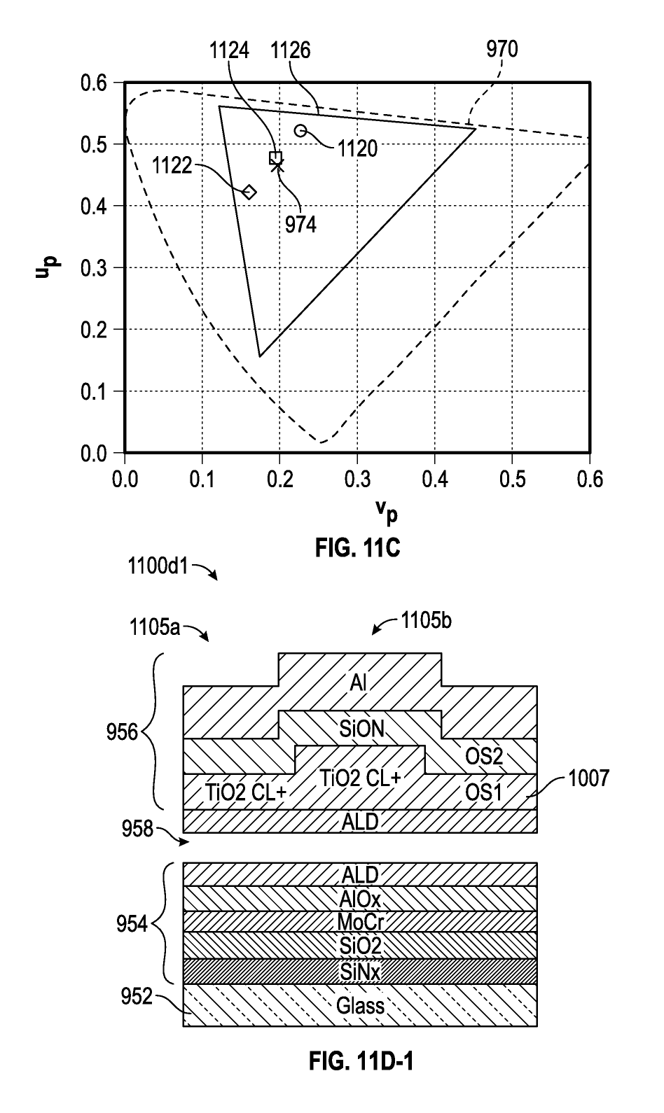

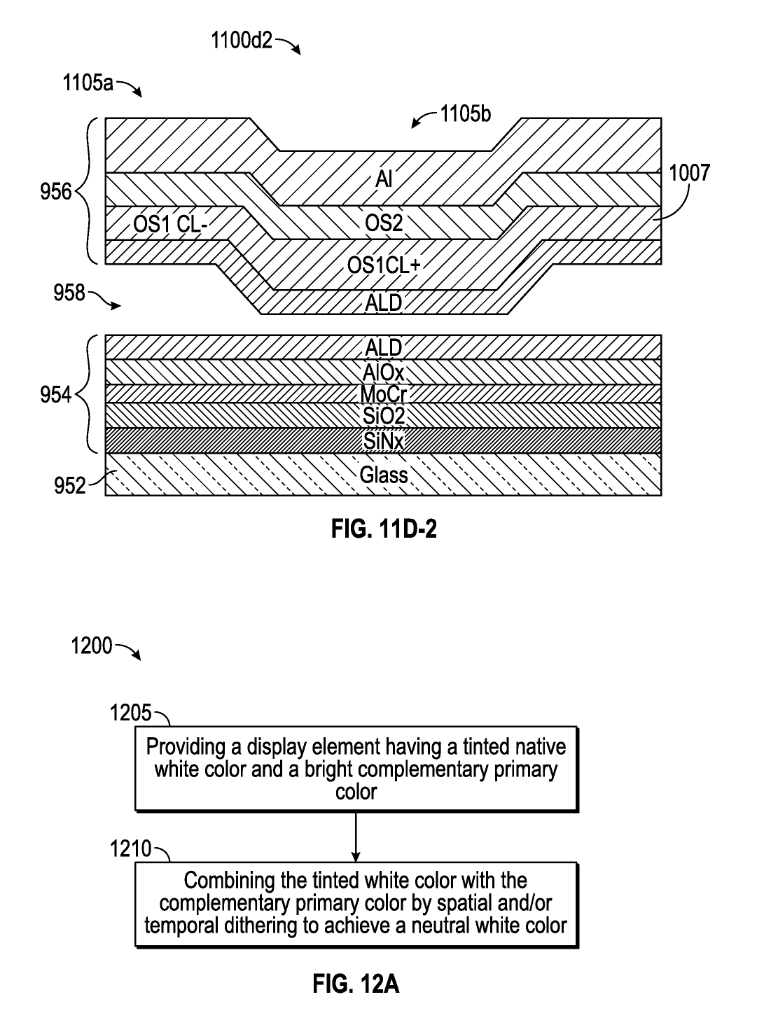

FIG. 11A illustrates an implementation of a display element 1100 including an optical stack 954 disposed over a substrate 952. The display element 1100 includes a first portion 1105a including a first movable reflector 956a disposed over the optical stack 954 and spaced apart from the optical stack 954 by an air gap 958. The display element 1100 further includes a second portion 1105b including a second movable reflector 956b also disposed over the optical stack 954 and spaced apart from the optical stack 954 by the identical air gap 958. In various implementations, the first movable reflector 956a and the second movable reflector layer 956b can be substantially identical to each other except for the thickness of the coating layers 1007a and 1007b. In various implementations, the coating layers 1007a/1007b can also be referred to as a complementary layer. For example in the illustrated implementations, the thickness of the coating layer 1007a included in the first movable reflector 956a is about 20 nm and the thickness of the coating layer while the thickness of the coating layer 1007b included in the second movable reflector 956b is about 46 nm. As discussed above, a display element with a thinner coating layer 1007a/1007b produces a cyanish-tinted white state and a display element with a thicker coating layer 1007a/1007b produces a yellowish-tinted white state. Accordingly, the first portion 1105a of the display element produces a cyanish-tinted white state and the second portion 1105b produces a yellowish-tinted white state. When the first and the second reflectors 956a and 956b are both in the down state (e.g., when the height of the gap 958 is between about 10 nm-20 nm), the average human brain will perceive the display element 1100 to display a neutral white color due to spatial mixing as discussed above.

FIG. 11B illustrates the reflectance spectrum 1112 of the first portion 1105a of the display element 1100 in the down state, the reflectance spectrum 1112 of the second portion 1105b in the down state and the combined reflectance spectrum 1114 produced by spatially and/or temporally dithering the two tinted white states. As discussed above, the first portion 1105a has a cyanish-tinted native white state in the down state. Accordingly, the reflectance spectrum 1112 of the first portion 1105a in the down state when the movable reflector 956a is spaced apart from the optical stack 954 by a distance between about 10 nm-about 20 nm has an intensity peak at about 460 nm. It is also noted from FIG. 11B that the first portion 1105a has a broad reflectance spectrum in the down state. For example, the full width at 65% maximum intensity (FW65M) for the reflectance spectrum 1112 is between about 100 nm-120 nm indicating that the cyanish-tinted native white state is bright.

As discussed above, the second portion 1105b of the display element 1100 has a yellowish-tinted native white state in the down state. Accordingly, the reflectance spectrum 1110 of the second portion 1105b in the down state when the movable reflector 956b is spaced apart from the optical stack 954 by a distance between about 10 nm-about 20 nm has an intensity peak between about 580 nm-about 610 nm. It is also noted from FIG. 11B that the second portion 1105b also has a broad reflectance spectrum in the down state. For example, the full width at 65% maximum intensity (FW65M) for the reflectance spectrum 1110 is between about 190 nm-200 nm indicating that the yellowish-tinted native white state is also bright.

The combined spectrum produced by spatially and/or temporally dithering the cyanish-tinted native white state produced by the first portion 1105a and the yellowish-tinted native white state produced by the second portion 1105b is shown by the spectrum 1114. It is noted from the spectrum 1114 that the combined spectrum has almost uniform intensity in the wavelength range between about 440 nm-about 600 nm indicating that the output produced by spatially and/or temporally dithering the cyanish-tinted native white state produced by the first portion 1105a and the yellowish-tinted native white state produced by the second portion 1105b of the display element 1100 is a neutral white color.

It is noted from the reflectance spectra shown in FIG. 11B that implementations of a display element including a first portion configured to produce a native white state with a first tint and a second portion configured to produce a native white state with a complementary tint can achieve a neutral white color that is substantially close to the D65 white point as observed from FIG. 11C. For example, a distance in a standard color space between the white state produced by an implementation of a display element including a first portion configured to produce a native white state with a first tint and a second portion configured to produce a native white state with a complementary tint and a D65 white point can be less than about 0.01. Additionally, the brightness level of the achieved white state can be increased. For example, in various implementations, the brightness level of the achieved white state can be maximized by optimizing the optical stack of the first portion 1105a and the second portion 1105b. In various implementations, the brightness level of the achieved white state can be between about 25%-30% under d8 illumination conditions. In various implementations, the brightness level of the achieved white state can be between about 85%-100% under indoor lighting conditions.

FIG. 11C illustrates the chromaticity diagram showing the neutral white color 1124 obtained by combining a cyanish-tinted white state 1122 produced by the first portion 1105a of a first implementation of the display element 1100 with a yellowish-tinted native white state 1120 produced by the second portion 1105b of the first implementation of the display element 1100 using spatial and/or temporal dithering. Also shown in FIG. 11C is the D65 white point 974, the sRGB color gamut 1126 and the monochromatic locus 970. The thickness of the coating layer 1007a in the first portion 1105a of the first implementation of the display element 1100 is 20 nm and the thickness of the coating layer 1007a in the second portion 1105b of the first implementation of the display element 1100 is 46 nm.

Another advantage of a display element including a first portion configured to produce a native white state with a first tint and a second portion configured to produce a native white state with a complementary tint is that both portions 1105a and 1105b can be driven simultaneously with a single drive signal.

The difference in the thickness of the coating layer 1007a/1007b in the first and second display elements 1005a and 1005b or the first and second portions 1105a and 1105b of the display element 1100 can result in a capacitance of the reflector layer 956a and 956b to be different for the first and second display elements 1005a and 1005b or the first and second portions 1105a and 1105b of the display element 1100. However, this change in the capacitance does not necessarily result in a change in the driving conditions. In fact, the variation of the air gap with respect to the applied voltage can be identical for the first and second display elements 1005a and 1005b or the first and second portions 1105a and 1105b of the display element 1100. Accordingly, the first and second display elements 1005a and 1005b or the first and second portions 1105a and 1105b of the display element 1100 can be driven using the driving systems and methods described herein.

FIGS. 11D-1 and 11D-2 illustrate different implementations of a display element 1100d1 and 1100d2 respectively, each implementation including a first portion 1105a configured to produce a tinted native white state and a second portion 1105b configured to produce a native white state with a complementary tint such that the implementations of the display element 1100d1 and 1100d2 are capable of achieving a neutral white color that is perceptually similar to a D65 white point. The display elements 1100d1 and 1100d2 include a single movable reflector 956. The thickness of the coating layer 1007 for the display elements 1100d1 and 1100d2 is different in the central region of the reflector 956 as compared to the peripheral region of the reflector 956. For example, in the illustrated implementations, the thickness of the coating layer 1007 in the central region of the reflector 956 is greater than the thickness of the coating layer 1007 in the peripheral region of the reflector 956. In such implementations, the central region of the reflector layer 956 is adapted to produce a yellowish-tinted native white state while the peripheral region of the reflector layer 956 is adapted to produce a cyanish-tinted white state. In other implementations, the thickness of the coating layer 1007 in the central region of the reflector 956 can be lesser than the thickness of the coating layer 1007 in the peripheral region of the reflector 956. In such implementations, the central region of the reflector layer 956 is adapted to produce a cyanish-tinted white state while the peripheral region of the reflector layer 956 is adapted to produce a yellowish-tinted native white state.

An advantage of the implementations 1100d1 and 1100d2 illustrated in FIGS. 11D-1 and 11D-2 is that a single display element (or pixel) is able to produce neutral white color without the need to spatial or temporal mixing with other pixels. However, the other primary colors produced by the implementations 1100d1 and 1100d2 can be impacted by the varying thickness of the coating layer 1007 across the surface of the display element. For example, gamut and contrast ratio of the display element can be reduce by color mixing between the portion of the display element having a first thickness for the coating layer 1007 and another portion of the display element having a second thickness for the coating layer 1007.

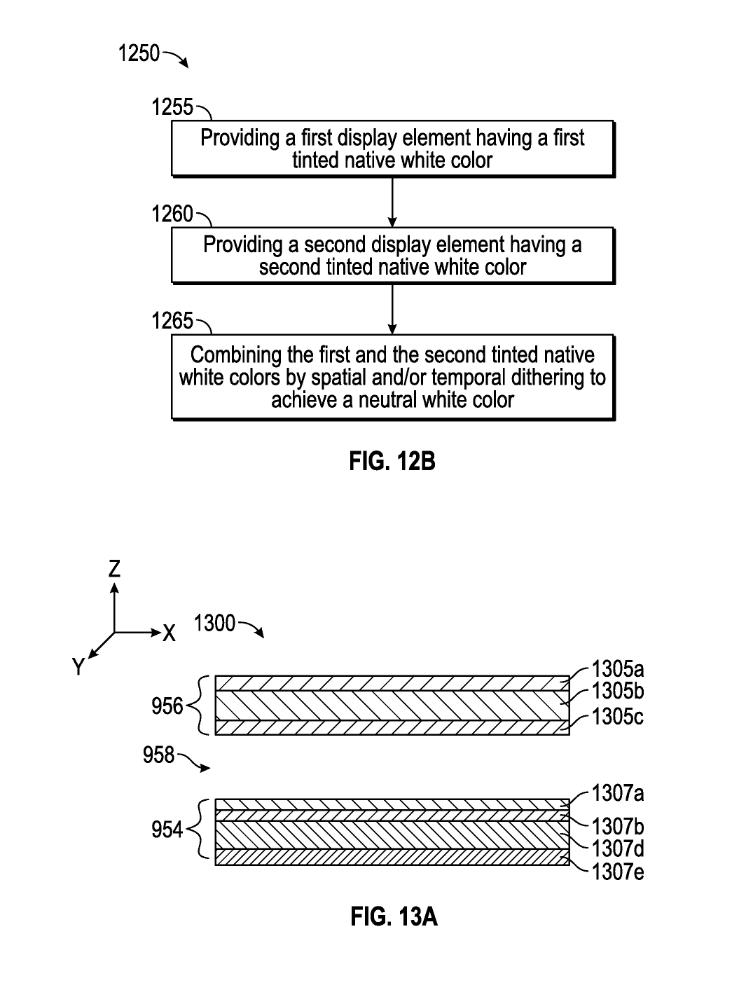

FIG. 12A is a flowchart that illustrates an example of a method 1200 of achieving a neutral white color of a display element (e.g., an IMOD, an AIMOD 900, display elements 950, 1005a, 1005b, 1100, 1100d1 and 1100d2). The method 1200 comprises providing a display element having a tinted native white state that has a bright complimentary primary color state as shown in block 1205. The display element can be adapted to have a yellowish-tinted native white state or a cyanish-tinted native white state as discussed above. The method 1200 further comprises combining the tinted white state (e.g., yellowish-tinted native white state or a cyanish-tinted native white state) with a complementary primary color by spatial and/or temporal dithering to achieve neutral white color as shown in block 1210. The neutral white color can be a D65 white point. The neutral white color can be within a threshold distance from the D65 white point in a standard color space (e.g., CIE 1976 (L, u*, v*) color space). For example, the neutral white color can be within a distance less than 0.01 from the D65 white point in the standard color space.

For a display element with a yellowish-tinted native white state the complementary primary color can be cyan while for a display element with a cyanish-tinted native white state the complementary primary color can be yellow. In the method 1200, the display element can be adapted to produce a bright tinted native white state having a brightness greater than a threshold brightness level. The complementary primary color also has a brightness that is at least 30% of the brightness of the tinted native white state such that the achieved white state has a luminance (Y) that is at least 30% measured along the specular direction without front screen optics. Furthermore, the tinted native white state and the complementary primary color have a contrast ratio less than a threshold contrast ratio such that the dither noise is less visible.

FIG. 12B is a flowchart that illustrates an example of a method 1250 of achieving a neutral white color of a display device including at least a first and a second display element (e.g., an IMOD, an AIMOD 900, display elements 950, 1005a, 1005b, 1100, 1100d1 and 1100d2). The method 1250 comprises providing a first display element having a first tinted native white state as shown in block 1255. The method 1250 further comprises providing a second display element having a second tinted native white state as shown in block 1260. The tint of the first native white state and the second native white state can be complementary to each other. For example, the first native white state can be a yellowish-tinted native white state and the second native white state can be a cyanish-tinted native white state as discussed above. The method 1250 further comprises combining the first and the second native white states (e.g., yellowish-tinted native white state and a cyanish-tinted native white state) by spatial and/or temporal dithering to achieve the neutral white color as shown in block 1265. As discussed above, the neutral white color can be a D65 white point. The neutral white color can be within a threshold distance from the D65 white point in a standard color space (e.g., CIE 1976 (L, u*, v*) color space). For example, the neutral white color can be within a chromaticity distance, given by \sqrt{(Δu′)²+(Δv′)²}, less than 0.01 from the D65 white point in the standard color space. In some implementations, a single display element can be configured to have a first portion that produces the first tinted native white state and a second portion that produces the second tinted native white state.

In various implementations of the display element (e.g., an EMS display element, an IMOD, an AIMOD 900, display elements 950, 1005a, 1005b, 1100, 1100d1 and 1100d2) the movable reflector (e.g., movable reflector layer 14, movable reflector 906, movable reflector 956, movable reflectors 956a/956b) can be configured to be curved such that a central region of the display device is configured to provide a tinted white state and the peripheral region of the display device is configured to provide a complementary or near complementary tinted white state. Due to spatial color mixing, the native white state of the display element is a combination of the color reflected by the central region and the peripheral regions of the display device. Such color mixing is able to produce a neutral or close to neutral white state color.

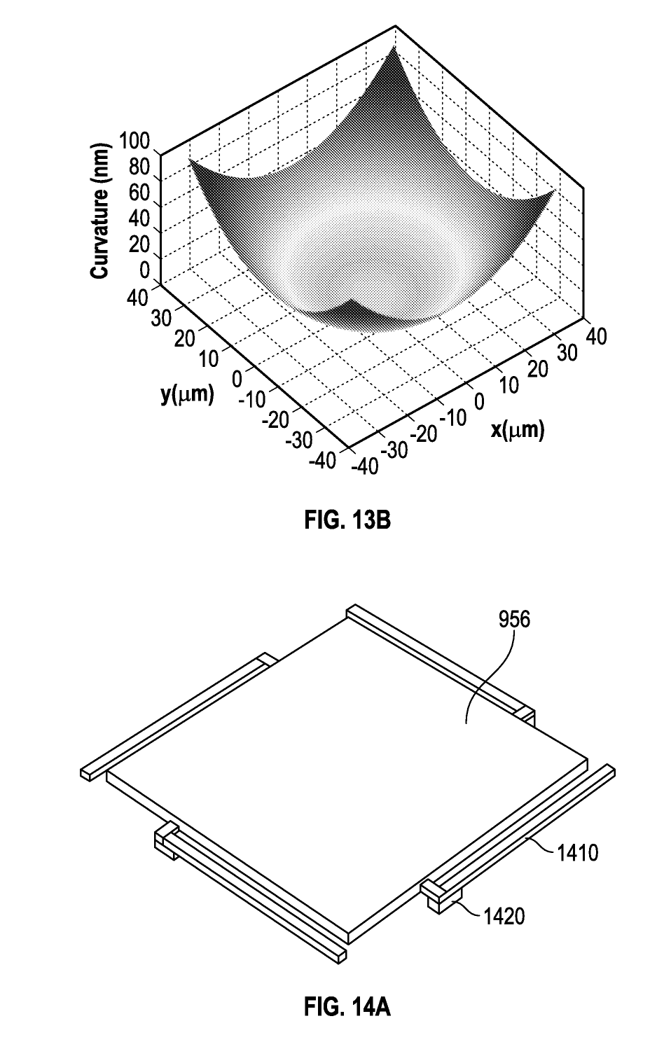

FIG. 13A illustrates an implementation of a display element 1300 in which the reflector 956 is configured to have a curvature. The implementation of the display element 1300 includes an optical stack 954 and a movable reflector 956 spaced apart from the optical stack 954 by a gap 958. The optical stack can include a plurality of layers 1307a, 1307b, 1307c, 1307d and 1307e. The movable reflector 956 can include a plurality of layer 1305a, 1305b, and 1305c. In some implementations, the layer 1305a can be a 40 nm thick layer of aluminum (Al), the layer 1305b can be a 72 nm thick layer of SiON, the layer 1305c can be a 27 nm thick layer of TiO₂. In some implementations, the layer 1307a can be a 9 nm thick layer of Al2O3, the layer 1307b can be a 7.5 nm thick layer of Vanadium, the layer 1307c can be a 27 nm thick layer of SiO₂ and the layer 1307d can be a 22 nm thick layer of Si₃N₄. In various implementations, the gap 958 can include air. The optical stack 954 in the illustrated implementation 1300 can be disposed over a substrate (e.g., substrate 952, substrate 20).

The implementation illustrated in FIG. 13A is a cross-sectional view along an axis (e.g., the z-axis) normal to the surface of the movable reflector 956 which extends along the x-y plane. FIG. 13B shows a top perspective view of the curved movable reflector 956 having a curvature in the x-y plane. The curvature of the movable reflector 956 varies along the surface of the movable reflector 956. In the illustrated implementation, the movable reflector 956 is concave with the central region of the reflector 956 curving inwards from the peripheral region. In other implementations, the movable reflector 956 can be configured to have a curvature such that it is convex. In various implementations, the surface of the movable reflector 956 can be aspheric or have other curvatures. In FIG. 13B, the movable reflector 956 is about 70 μm long along the x-direction and about 70 μm long along the y-direction. The maximum curvature in the central region for the implementation illustrated in FIG. 13B is about 80 nm. In other implementations, the dimensions of the movable reflector layer 956 and the curvatures can have different values. For example, in various implementations, the maximum curvature in the central region can be greater than or equal to 0 nm and less than or equal to 100 nm; greater than or equal to 0 nm and less than or equal to 90 nm; greater than or equal to 5 nm and less than or equal to 80 nm; greater than or equal to 10 nm and less than or equal to 70 nm; greater than or equal to 15 nm and less than or equal to 65 nm; greater than or equal to 20 nm and less than or equal to 60 nm; greater than or equal to 30 nm and less than or equal to 50 nm; greater than or equal to 35 nm and less than or equal to 450 nm, greater than or equal to 30 nm and less than or equal to 40 nm, or values in between.

In various implementations, the curved movable reflector 956 can be connected to a plurality of support posts (e.g., posts 18) disposed over the optical stack 954 via tethers or hinges. The posts can be disposed proximate to the corners of the substrate (e.g., substrate 952 or substrate 20) on which the optical stack 954 is disposed. The tethers or hinges can be symmetrically disposed around the movable reflector 956. In some implementations, the tethers can be tangential to the movable reflector 956 and can advantageously reduce the residual stress in the display device. Other configurations for tethers, including straight, curved, or folded, are also possible. The deflection of the movable reflector 956 towards the optical stack 954 can increase as the compliance of the tethers increases. In particular, the compliance of the tethers can vary linearly with the inverse of its width, and can vary directly with the cube of its length. Thus, the tethers can be longer and thinner so as to increase the deflection of the movable reflector 956. Moreover, the tethers can be made of the same material and have substantially the same compliance, which can lead to a substantially uniform deflection for the movable reflector 956. For example, the tethers can be include materials such as aluminum (Al) and titanium (Ti), silicon (Si), oxides, nitrides, and oxynitrides.

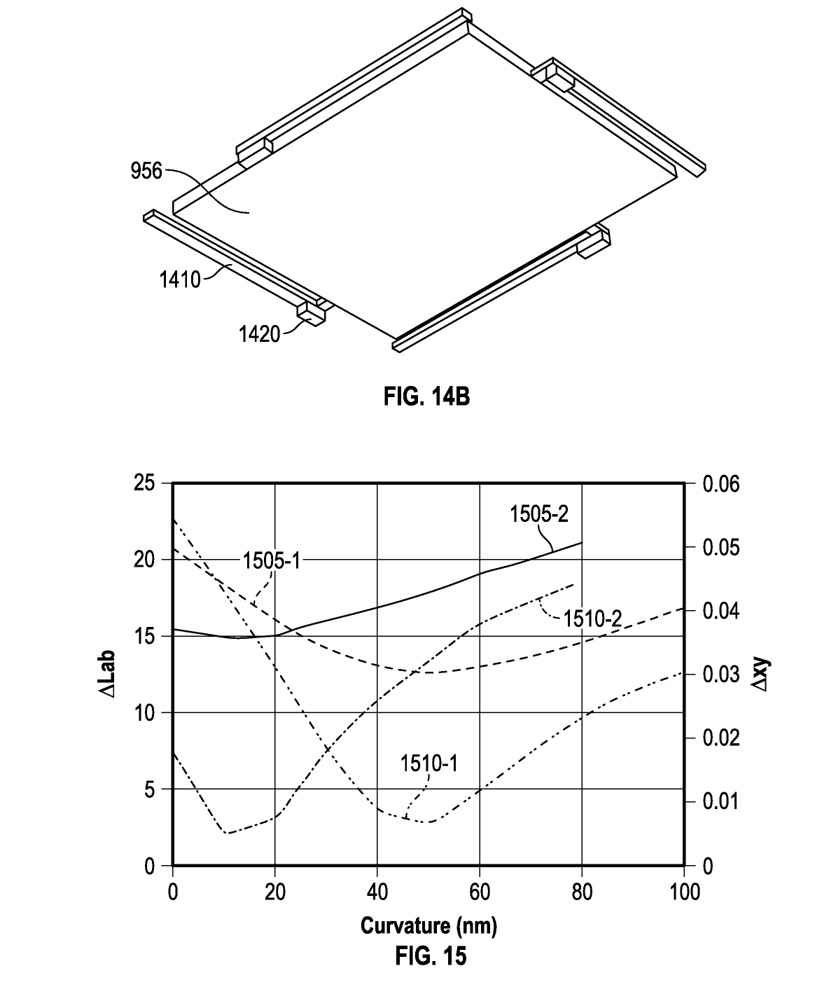

FIG. 14A shows a perspective top view of an implementation of a movable reflector 956 of display device including a plurality of tethers 1410. In various implementations some of the tethers 1410 can have a protrusion 1420. FIG. 14B shows a perspective bottom view of the movable reflector 956 depicted in FIG. 14A. The protrusions 1420 can also be referred to as “dimples.” In some implementations as illustrated in the example in FIGS. 14A and 14B, the protrusion 1420 can be disposed on the tether 1410. The protrusions 1420 can connect to and extend from the surface of the tether 1410 facing the optical stack 954. As the tether 1410 can be symmetrically disposed around the movable reflector 956, the protrusion 1420 can also be symmetrically disposed around the movable reflector 956. The protrusions 1420 can be rotationally symmetric about the center of the movable reflector 956. The protrusion 1420 can be positioned proximate to where the tether 1410 attaches to the movable reflector 956. In the example in FIGS. 14A and 14B, each of the four tethers 1410 disposed around the periphery of the movable reflector 956 includes a protrusion 1420. However, it is understood that fewer protrusions 1420 or more protrusions 1420 can be disposed around the periphery of the movable reflector 956.

The effect of the protrusion 1420 is to shorten the effective length of the tether 1410 it is disposed on. Accordingly, the protrusion 1420 can increase the stiffness of the tether 1410 it is disposed on and the overall stiffness of the display device. The increase in the stiffness of display device can depend on the position of the protrusion 1420 relative to the tether 1410. Another effect of the protrusion 1420 is to increase resistance to deformation of the tether 1410 or the movable reflector 956. In some implementations, for example, the protrusion 1420 can change the compliance of the tether 1410 or the movable reflector 956 so that the movable reflector 956 continues to move towards the optical stack 954 in response to an electrostatic force while reducing the effects of snap-through.

The protrusion 1420 may be connected to or make contact with a non-rigid surface of the display device. For example, in some implementations, the protrusion 1420 can be connected to a non-rigid surface of the movable reflector 956 or the tether 1410. In such implementations, as the protrusion 1420 makes contact with another surface of the display device, the protrusion 1420 can cause the non-rigid surface to flex. Thus, as the movable reflector 956 continues to move, some of the regions on the tether 1410 or on the movable reflector 956 that are not in contact with the protrusion 1420 can bend.

In some implementations, the protrusion 1420 may make contact with a non-rigid surface of the movable reflector 956 or tether 1410. The protrusion 1420 may be connected to or otherwise positioned on the substrate (e.g., substrate 952 or substrate 20) or the optical stack 954, and need not be connected to a non-rigid surface. In such implementations, during actuation, as the protrusion 1420 makes contact with a non-rigid surface of the movable reflector 956 or the tether 1410, it can cause the non-rigid surfaces to flex. Hence, as the movable reflector 956 continues to move, some of the regions on the tether 1410 or on the movable reflector 956 that are not in contact with the protrusions 1420 can bend.

In some implementations, the movable reflector 956 can collapse towards the optical stack 954 when the electrostatic force is greater than the mechanical restoring force of the tether 1410 and the movable reflector 956. Contact of the protrusion 1420 with any surface of the EMS device increases the mechanical restoring force so that the electrostatic force needs to be increased to a greater degree to overcome restoring force. Depending on the size and number of the protrusions, the mechanical restoring force can be even larger. Hence, the protrusion 1420 can increase the overall stiffness of the display device and slow the effects of snap-through, allowing for additional stable regions across the gap 958.

In some implementations, the thickness or height, h, of the protrusion 1420 can be greater than about 20 nm. In various implementations, the protrusion 1420 can have a height greater than the inherent surface roughness or topography of the movable reflector 956/optical stack 954. The protrusion 1420 also can have a height greater than the dimensions of bumps provided for anti-stiction purposes. In some implementations, the height of the protrusion 1420 can be between about 20 nm and about 4000 nm, such as between about 100 nm and about 200 nm. The height of the protrusions 100 can depend on the desired stable region of the gap between the movable reflector 956 and the optical 954. In some implementations, the protrusions provided on different tethers disposed around the periphery of the movable reflector 956 can have a different height.

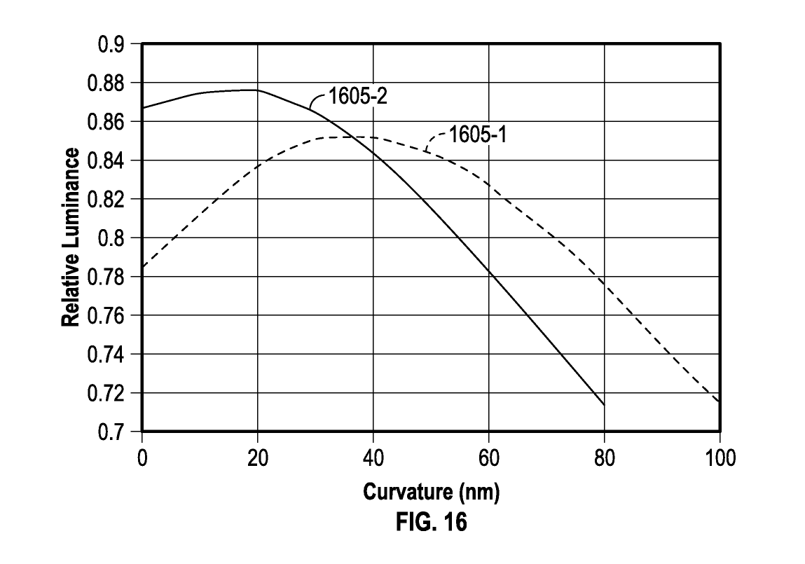

The curvature of the movable reflector 956 can be adjusted to provide a neutral native white state that is within a threshold distance from the D65 white point in a standard color space and has a brightness (or luminance) level greater than a threshold brightness (or luminance) level. The curvature of the movable reflector that provides the brightest neutral white color that is within a threshold distance from the D65 white point in a standard color space can depend on the configuration of the display element 1300. For example, the curvature of the movable reflector 956 that provides the brightest neutral white color that is within a threshold distance from the D65 white point in a standard color space in implementations of display device in which the movable reflector 956 is attached to the posts with tethers including protrusions can be about 15 nm. In contrast, the curvature of the movable reflector 956 that provides the brightest neutral white color that is within a threshold distance from the D65 white point in a standard color space in implementations of display device in which the movable reflector 956 is attached to the posts with tethers without protrusions can be about 50 nm. This is illustrated below with reference to FIGS. 15 and 16

FIG. 15 illustrates the variation of color difference as a function of curvature of the movable reflector 956 for different configurations of the display device. Curve 1505-1 illustrates the distance between the D65 white point and the native white state produced by a display device having a first configuration in the 1976 CIELAB color space for different curvatures of the movable reflector 956. In the first configuration of the display device, the movable reflector 956 is attached to the posts with tethers without protrusions (also referred to as display device without dimples).

Referring to FIG. 15, curve 1505-2 illustrates the distance between the D65 white point and the native white state produced by a display device having a second configuration in the 1976 CIELAB color space for different curvatures of the movable reflector 956. In the second configuration of the display device, the movable reflector 956 is attached to the posts with tethers including protrusions (also referred to as display device with dimples). The distance (ΔLab)) between the D65 white point and the native white state produced by a display device in the 1976 CIELAB color space can be calculated using the equation (A) below:

ΔLab=(L−L_{D65})²+(a−a_{D65})²+(b−b_{D65})² (A),

where (L,a,b) are the coordinates of the native white state displayed by the implementation of the display device in the first or second configuration for a particular curvature of the movable reflector 956 in the 1976 CIELAB color space and (L_{D65}, a_{D65}, b_{D65}) are the coordinates of the D65 white point in the 1976 CIELAB color space.

Still referring to FIG. 15, curve 1510-1 illustrates the distance between the D65 white point and the native white state produced by a display device without dimples in the CIE 1931 XYZ color space for different curvatures of the movable reflector 956 and curve 1510-2 illustrates the distance between the D65 white point and the native white state produced by a display device with dimples in the CIE 1931 XYZ color space for different curvatures of the movable reflector 956. The distance (Δxy) between the D65 white point and the native white state produced by a display device in the CIE 1931 XYZ color space can be calculated using the equation (B) below:

Δxy=\sqrt{(x−x_{D65})²+(y−y_{D65})²} (B),

where (x,y) are the coordinates of the native white state displayed by the implementation of the display device in the first or second configuration for a particular curvature of the movable reflector 956 in the CIE 1931 XYZ color space and (x_{D65},y_{D65}) are the coordinates of the D65 white point in the CIE 1931 XYZ color space. The distance (ΔLab) and (Δxy) can provide a measure of the color difference between the achieved native white state and the D65 white point.

It is observed from FIG. 15 that for display devices without dimples (first configuration), the distance (ΔLab) between the D65 white point and the native white state is less than about 13.0 for curvatures of the movable reflector 956 between about 40 nm and about 60 nm. It is also observed that the distance (ΔLab)) between the D65 white point and the native white state produced by the display device without dimples having a movable reflector 956 with a curvature of about 50 nm is the lowest. This is also corroborated by the observations made from curves 1510-1 which indicates that the distance (Δxy) between the D65 white point and the native white state is less than 0.01 for curvatures of the movable reflector 956 between about 35 nm and about 60 nm. Further observations from curve 1510-1 indicate that the distance (Δxy) between the D65 white point and the native white state produced by the display device without dimples having a movable reflector 956 with a curvature of about 50 nm is the lowest.

It is also noted from FIG. 15 that for display devices with dimples (second configuration), the distance (ΔLab) between the D65 white point and the native white state is less than about 15.0 for curvatures of the movable reflector 956 between about 10 nm and about 30 nm. It is also observed that the distance (ΔLab)) between the D65 white point and the native white state produced by the display device with dimples having a movable reflector 956 with a curvature of about 15 nm is the lowest. This is corroborated by the observations made from curves 1510-2 which indicates that the distance (Δxy) between the D65 white point and the native white state is less than 0.01 for curvatures of the movable reflector 956 between about 10 nm and about 30 nm. Further observations from curve 1510-2 indicate that the distance (Δxy) between the D65 white point and the native white state produced by the display device without dimples having a movable reflector 956 with a curvature of about 15 nm is the lowest.

FIG. 16 illustrates the variation of relative luminance as a function of curvature of the movable reflector for different configurations of the display device. Curve 1605-1 illustrates the relative luminance of the native white state produced by a display device without dimples (in the first configuration) for different curvatures of the movable reflector 956. Curve 1605-2 illustrates the relative luminance of the native white state produced by a display device with dimples (in the second configuration) for different curvatures of the movable reflector 956. It is observed that the relative luminance decreases as the curvature of the movable reflector 956 increases. It is also observed that the display device with dimples has a higher relative luminance value as compared to the display device without dimples. The maxima of curve 1505-1 occurs at a curvature of about 40 nm and the maxima of the curve 1505-2 occurs at a curvature of about 20 nm. Accordingly, it is noted that the curvature that produces the brightest native white state may not provide the lowest distance in a standard color space between the native white state and the D65 white point. However, it is noted from curve 1605-2 that a difference in the relative luminance of the native white state at a curvature of about 15 nm for a display device with dimples (which achieves the lowest color difference) and the maximum relative luminance is less than 0.02. Similarly, it is noted from curve 1605-1 that a difference in the relative luminance of the native white state at a curvature of about 50 nm for a display device without dimples (which achieves the lowest color difference) and the maximum relative luminance is also less than 0.02. Thus, the curvature that corresponds to the lowest color difference between the achieved native white state and the D65 white point may still be sufficiently bright.

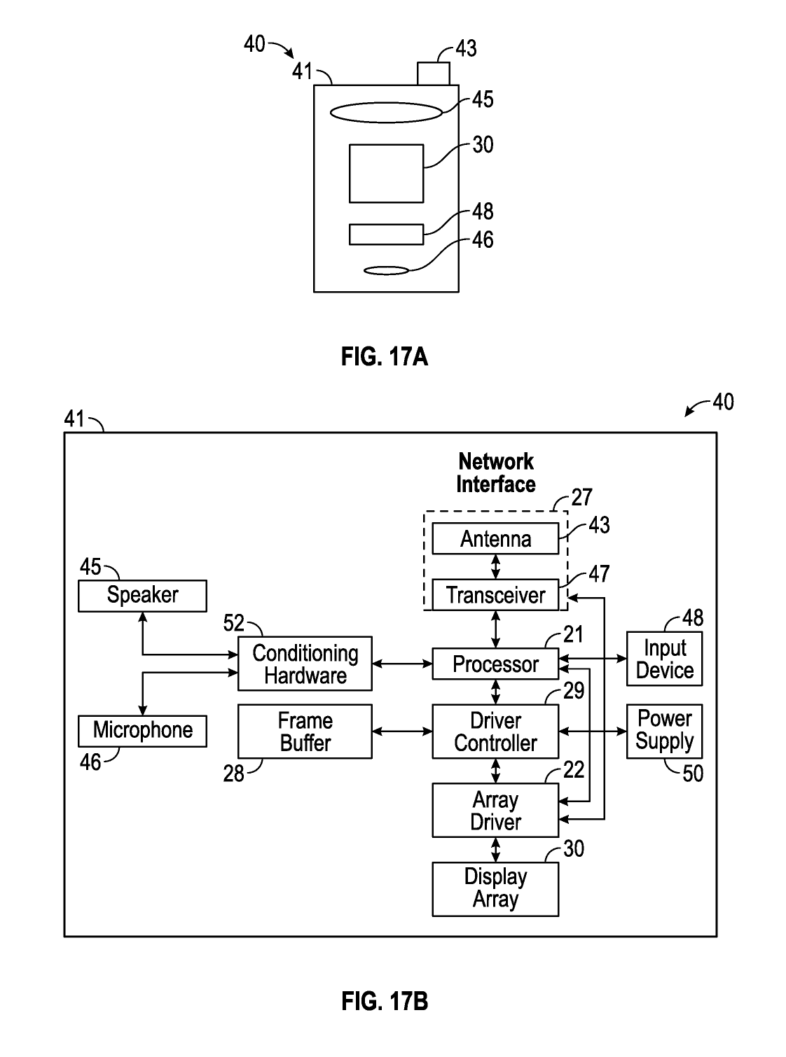

FIGS. 17A and 17B are system block diagrams illustrating a display device 40 that includes a plurality of IMOD display elements including but not limited to implementations similar to AIMOD 900, display elements 950, 1005a, 1005b, 1100, 1100d1 and 1100d2. The display device 40 can be configured to use temporal (and/or spatial) modulations schemes to achieve a neutral white color. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 17A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 17A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level. The processor 21 (or other computing hardware in the device 40) can be in communication with a computer-readable medium that includes instructions, that when executed by the processor 21, cause the processor 21 to perform implementations of the methods described herein such as the method 1200.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). The driver controller 29 and/or the array driver 22 can be an AIMOD controller or driver. In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described methods for generating a constrained color palette may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display device comprising:
a first display element and a second display element, each of the first and second display elements including a movable reflector disposed over a substrate, the movable reflector spaced apart from the substrate by a gap,
wherein the first display element is configured to produce a first tinted native white color and the second display element is configured to produce a second tinted native white color, the tint of the first tinted native white color being complementary to the tint of the second tinted native white color, and
wherein a height of the gap of the first display element is configured to display the first tinted native white color and a height of the gap of the second display element is configured to display the second tinted native white color such that a neutral white color is produced by combining the first and the second tinted native white colors using spatial dithering.

2. The display device of claim 1, wherein the first native white color is a yellowish-tinted white state having a color temperature between about 3000 K and about 4500 K measured along the specular direction with a D65 source without front screen optics.

3. The display device of claim 2, wherein the movable reflector of the first display element includes a coating layer having a thickness between about 38 nm and about 54 nm.

4. The display device of claim 3, wherein the coating layer includes titanium oxide.

5. The display device of claim 1, wherein the second tinted native white color is a cyanish-tinted native white color having a color temperature between about 8500 K and about 20,000 K measured along the specular direction with a D65 source without front screen optics.

6. The display device of claim 5, wherein the movable reflector of the second display element includes a coating layer having a thickness between about 12 nm and about 28 nm.

7. The display device of claim 6, wherein the coating layer includes titanium oxide.

8. The display device of claim 1, further comprising a first display pixel including the first display element and a second display pixel including the second display element.

9. The display device of claim 8, wherein the first and the second display pixels are adjacent to each other in a checkboard pattern or a random pattern.

10. A display device comprising:
a display element including a first optical cavity and a second optical cavity, the first optical cavity comprising a first portion of a movable reflector disposed over a substrate, the second optical cavity comprising a second portion of the movable reflector disposed over the substrate,
wherein the first optical cavity is configured to produce a first tinted native white color and a plurality of display primary colors,
wherein the second optical cavity is configured to produce a second tinted native white color and a plurality of display primary colors,
wherein the first and the second tinted native white colors are complementary to each other, and
wherein a height of a gap between the first optical cavity and the substrate is configured to produce the first tinted native white color, and wherein a height of a gap between the second optical cavity and the substrate is configured to produce the second tinted native white color, such that display element displays a neutral white color produced by combining the first and the second tinted native white colors using spatial color mixing.

11. The display device of claim 10, wherein the first tinted native white color is a yellowish-tinted white color having a color temperature between about 3000 K and about 4500 K measured along the specular direction with a D65 source without front screen optics.

12. The display device of claim 11, wherein the first portion of the movable reflector includes a coating layer having a thickness between about 38 nm and about 54 nm.

13. The display device of claim 12, wherein the coating layer includes titanium oxide.

14. The display device of claim 10, wherein the second tinted native white color is a cyanish-tinted native white color having a color temperature between about 8500 K and about 20000 K measured along the specular direction with a D65 source without front screen optics.

15. The display device of claim 14, wherein the second portion of the movable reflector includes a coating layer having a thickness between about 12 nm and about 28 nm.

16. The display device of claim 15, wherein the coating layer includes titanium oxide.

17. A display device comprising:
a first means for displaying and a second means for displaying, each of the first and second displaying means including a movable means for reflecting disposed over a substrate, the movable reflecting means spaced apart from the substrate by a gap,
wherein the first displaying means is configured to produce a first tinted native white color and the second displaying means is configured to produce a second tinted native white color, the tint of the first tinted native white color being complementary to the tint of the second tinted native white color, and
wherein a height of the gap of the first displaying means is configured to display the first tinted native white color and a height of the gap of the second displaying means is configured to display the second tinted native white color such that a neutral white color is produced by combining the first and the second tinted native white colors using spatial dithering.

18. The display device of claim 17, wherein the first displaying means includes a first display element and the second displaying means includes a second display element, or wherein the first displaying means includes a first optical cavity and the second displaying means includes a second optical cavity.

19. The display device of claim 17, wherein the reflecting means includes a reflector, or wherein the reflecting means includes a portion of a reflector.
